(19) United States
(12) Patent Application Publication
(10) Pub. No.: US 2015/0234881 A1
(43) Pub. Date: Aug. 20, 2015

(54) Person Authentication Dictionary Update Method, Person Authentication Dictionary Update Apparatus, Recording Medium, and Person Authentication System

(71) Applicant: NEC BIGLOBE, LTD., Tokyo (JP)

(72) Inventors: Kyoji Hirata, Tokyo (JP); Takeshi Kawasaki, Tokyo (JP); Michitaro Miyata, Tokyo (JP); Kazuya Furukawa, Tokyo (JP)

(73) Assignee: BIGLOBE Inc., Tokyo, JP (JP)

(21) Appl. No.: 14/429,572

(22) PCT Filed: Jul. 19, 2013
(86) PCT No.: PCT/JP2013/070257

§ 371 Date: Mar. 19, 2015

(30) Foreign Application Priority Data
Sep. 25, 2012 (JP) 2012-211273

(51) Int. Cl. G06F 17/30; G06F 17/27; G06F 21/60

(52) U.S. Cl. CPC G06F 17/30348; G06F 21/604; G06F 17/2735

(57) ABSTRACT

For the purpose of appropriately updating dictionary information in accordance with a change caused by a medium-to-long term temporal change caused by aging or a characteristics change of the target person, a method of updating a person authentication dictionary for storing biological information of a person of recognition target, includes: a storage step of storing and accumulating inquiry biological information received within a predetermined term, into a history accumulation unit; a generation step of measuring a similarity of the accumulated inquiry biological information pieces and then generating the similarity of each pair of biological information pieces; and an update step of, on the basis of a pair of biological information pieces judged as having a high similarity, updating the person authentication dictionary.

### TECHNICAL FIELD

The present invention relates to a person recognition method and a person recognition apparatus for, by using biological information such as a face image, a fingerprint image, iris information, a shape-of-palm image, a finger image, and speech information of a person, recognizing the person and, more specifically, to a method and an apparatus for updating a person authentication dictionary used in accumulation and storage for person authentication.

### BACKGROUND ART

In security administration or the like, a large number of person recognition apparatuses (person authentication apparatuses) and services for, by using biological information such as a face image, a fingerprint image, iris information, a shape-of-palm image, a finger image, and speech information of a person, recognizing (authenticating) the person have been proposed and are operated in practice.

In general, in a person authentication apparatus of this kind, biological information of a person of recognition target is acquired, then the acquired biological information is compared with registered information held in a registered information accumulation unit for storing in advance as registered information the biological information of the person of recognition target so that the similarity of these is obtained, and then the person is recognized (authenticated) on the basis of the obtained similarity (for example, see Patent Documents 1 to 3).

In such a person authentication apparatus, a problem that the person in question is excluded erroneously has been caused by a temporal change in which the biological information such as the personal appearance of the target person varies in association with the continuation of operation of the system so that biological information inputted newly becomes different from the registered information held in the registered information holding unit or, alternatively, by an input variation in association with a fluctuation in the input condition (the direction of image taking, the environment, the posture). For the purpose of reducing such a problem, techniques have been proposed concerning the update of a dictionary (the registered information holding unit) in which the biological feature information of the person in question is recorded in advance as registered information.

For example, a person-in-question identification apparatus is known in which, in addition to an authentication threshold, a re-registration threshold higher than the authentication threshold is set up and then, when the similarity obtained at the time of comparison is higher than the re-registration threshold, the registered information (the dictionary) is updated (for example, see Patent Document 4).

Further, a person-in-question identification apparatus is known in which a mechanism for lowering the authentication threshold in combination with the input of an ID number or a PIN number and then, when the comparison has been successful without lowering the authentication threshold, the registered information (the dictionary) is updated (for example, see Patent Document 5).

Further, Patent Document 6 discloses a person recognition apparatus in which, when the similarity at the time of comparison falls in advance within a predetermined update range, the registered information (the dictionary) is updated. In the person recognition apparatus disclosed in Patent Document 6, when tentative registered information is generated, the similarity is calculated relative to one or a plurality of the face feature information pieces inputted in the past and stored in a history information storage section. Similarly, in the person recognition apparatus, the same processing is performed on the existing registered information stored in a registered information storage section so that the similarity is calculated. As a result, when the tentative registered information has a higher average similarity to the one or a plurality of feature information pieces inputted in the past, in the person recognition apparatus, the registered information stored in a registered information holding section is replaced by the tentative registered information so that the tentative registered information is registered as the original dictionary.

Further, a large number of methods have been proposed as extraction methods for a face feature quantity from a static image and as similarity calculation methods employing a face feature quantity. As an example, Patent Document 7 describes an extraction method for a face feature quantity and a similarity calculation method employing the face feature quantity.

Patent Document 8 discloses a biological information authentication apparatus employed in biological information authentication in which authentication by spoofing performed by a third person other than the person in question is avoided regardless of the method of falsification of the biological information. In the biological information authentication apparatus disclosed in this Patent Document 8, when the similarity between the inquiry input and the dictionary data is higher than a fixed value, being the same person is concluded. However, when the maximum score of the inquiry in the past is exceeded, spoofing is concluded (because of excessive resemblance).

Further, Patent Document 9 discloses a face image comparison apparatus in which, even when similar face patterns are present in a face comparison dictionary, the comparison performance and the security level can be maintained at certain levels. In the face image comparison apparatus disclosed in Patent Document 9, it is described that historical data of the face image is maintained. Nevertheless, the historical data is used for a purpose that the face image based on the historical data is displayed on a display of a storage PC and then an administrator identifies a suspicious person or an addict of mischief of unauthorized access.

Patent Document 10 discloses a face image registration apparatus in which a plurality of face images are registered as dictionary data by using video images. In the face image registration apparatus disclosed in Patent Document 10, a front-side face is extracted from the input video image and, after that, images having variations in the face orientation, the presence or absence of a mustache, or the like are extracted from the same video (by using conformity by tracking) as candidates for dictionary data and then stored. Further, in the face image registration apparatus disclosed in Patent Document 10, which of a face image registered in the face image dictionary and a face image newly extracted for registration is suitable for face authentication is judged by using comparison of recognition reliabilities. Then, in the face image registration apparatus disclosed in Patent Document 10, when it is judged that the newly extracted face image is more suitable for face authentication, the existing face image is replaced by the newly extracted face image. Here, the “recognition reliability” indicates a numerical value expressing the degree of satisfaction of a pickup condition. In case of the face orientation, the value is 5 degrees or 8 degrees.

Patent Document 11 discloses a three-dimensional-object registration apparatus in which, even when the image-taking condition at the time of image taking of an image-taking object is different for each image-taking object, erroneous authentication is suppressed. In the three-dimensional-object registration apparatus disclosed in Patent Document 11, data pieces obtained by image taking under various image-taking conditions (including the environment and the direction) are accumulated in advance as dictionary data. Then, the image-taking condition of the inputted inquiry image is extracted and then comparison is performed relative to one obtained under the most similar image-taking condition so that erroneous recognition is suppressed.

### PRIOR ART REFERENCE

### Patent Document

Patent Document 1: Japanese Patent Laid-Open Publication No. 2003-058508

Patent Document 2: Japanese Patent Laid-Open Publication No. H11-161790

Patent Document 3: Japanese Patent Laid-Open Publication No. 2005-032051

Patent Document 4: Japanese Patent Laid-Open Publication No. H11-167632

Patent Document 5: Japanese Patent Laid-Open Publication No. H10-312462

Patent Document 6: Japanese Patent Laid-Open Publication No. 2004-157602 (Paragraph [0072])

Patent Document 7: Japanese Patent Laid-Open Publication No. 2002-157595

Patent Document 8: Japanese Patent Laid-Open Publication No. 2011-059791

Patent Document 9: Japanese Patent Laid-Open Publication No. 2008-071366

Patent Document 10: Japanese Patent Laid-Open Publication No. 2007-249588 (Paragraph [0142])

Patent Document 11: Japanese Patent Laid-Open Publication No. 2007-164401

### SUMMARY OF INVENTION

### Problems to be Solved by the Invention

In a system for performing authentication for a medium-to-long term, it is preferable that biological information registered as dictionary information is updated in accordance with a medium-to-long term temporal change caused by aging or a characteristics change of the target person but the biological information is not updated even when a change is caused by variation in the input situation including a certification condition, an input direction, and timing or, alternatively, a short-term change occurs like painting in the face.

Nevertheless, in the above-mentioned recognition systems having been proposed, the similarity alone is evaluated between the dictionary registered information and the inputted biological information. This causes a problem of difficulty in achieving the update of the dictionary information in a state that a change associated with a medium-to-long term temporal change, a change caused by variation in the input situation, and a short-term change are distinguished.

### OBJECT OF THE INVENTION

The present invention has been devised in view of such situations. An object of the present invention is to realize dictionary information update in which dictionary information used for person recognition (authentication) is updated in accordance with a medium-to-long term temporal change alone of the user and hence the recognition (authentication) accuracy is not changed owing to variation in the input situation or to a short-term change so that the update is achieved in accordance with the present situation of the biological information of the user.

### Means for Solving to the Problems

A mode of the present invention is characterized by a method of, by using a person authentication dictionary update apparatus, updating a person authentication dictionary for storing biological information of a person of recognition target, comprising: a storage step of storing and accumulating inquiry biological information received within a predetermined term, into a history accumulation unit; a generation step of measuring a similarity of the accumulated inquiry biological information pieces and then generating the similarity of each pair of biological information pieces; and an update step of, on the basis of a pair of biological information pieces judged as having a high similarity, updating the person authentication dictionary.

### Advantageous Effects of the Invention

An effect of the present invention is that information in a person authentication dictionary can be updated in accordance with a medium-to-long term fluctuation (a temporal change or the like) in the target person. This permits stable and accurate recognition (authentication) of a person for medium-to-long term operation. Further, without an influence from input variation or a short-term feature fluctuation, dictionary construction based on stable features alone can be achieved and hence accurate person recognition (authentication) can be realized.

### BRIEF DESCRIPTION OF THE DRAWINGS

FIG. 1 is a block diagram of a person authentication apparatus in a first embodiment of the present invention.

FIG. 2 is a flow chart describing a first person authentication dictionary update method of a person authentication apparatus shown in FIG. 1.

FIG. 3 is a diagram schematically showing a mechanism of dictionary update based on an inquiry history.

FIG. 4 is a diagram describing permission or non-permission judgment for update of a dictionary.

FIG. 5 is a diagram describing permission or non-permission judgment for update of a dictionary.

FIG. 6 is a block diagram of a person authentication apparatus in a second embodiment of the present invention.

FIG. 7 is a flow chart describing a second person authentication dictionary update method of a person authentication apparatus shown in FIG. 6.

FIG. 8 is a diagram schematically showing an example of a method of updating an inquiry history.

FIG. 9 is a diagram showing an example of an update criterion for an inquiry history.

FIG. 10 is a block diagram of a person authentication system in a third embodiment of the present invention.

FIG. 11 is a diagram showing an example of a service utilization method employing a person authentication system shown in FIG. 10.

### DESCRIPTION OF THE EMBODIMENTS

### First Embodiment

A first embodiment for implementing the present invention is described below with reference to the drawings.

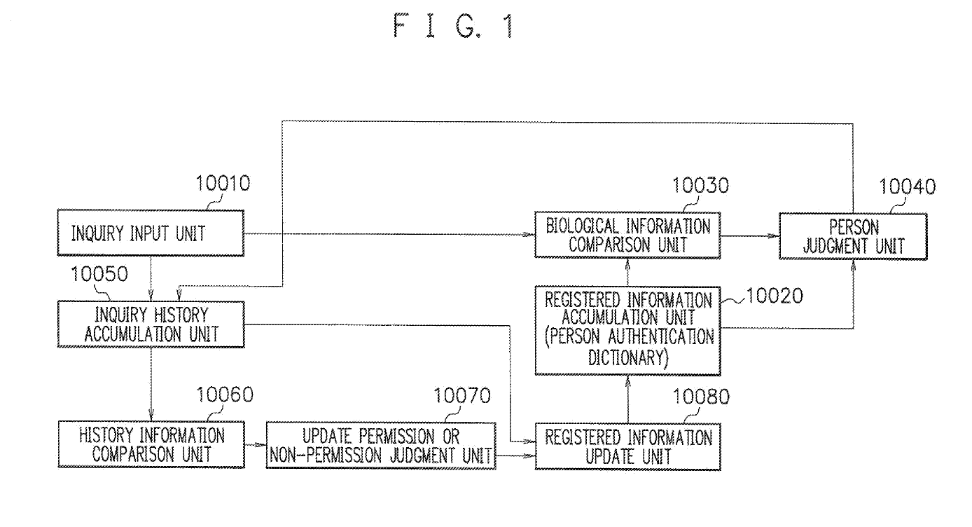

Referring to FIG. 1, a person authentication apparatus according to the first embodiment of the present invention is constructed from, an inquiry input unit 10010, a registered information accumulation unit 10020, a biological information comparison unit 10030, a person judgment unit 10040, an inquiry history accumulation unit 10050, a history information comparison unit 10060, an update permission or non-permission judgment unit 10070, and a registered information update unit 10080.

The inquiry input unit 10010 receives input of biological information of a person for the purpose of recognition. The registered information accumulation unit 10020 stores in advance, as registered information, biological information of a person of recognition target. The biological information comparison unit 10030 calculates the similarity between the biological information inputted through the inquiry input unit 10010 and the biological information held in the registered information accumulation unit 10020 so as to perform comparison. The person judgment unit 10040 identifies the target person on the basis of the similarity calculated by the biological information comparison unit 10030.

The inquiry history accumulation unit 10050 accumulates the biological information inputted through the inquiry input unit 10010. The history information comparison unit 10060 calculates a similarity between biological information pieces held in the inquiry history accumulation unit 10050. The update permission or non-permission judgment unit 10070 judges update permission or non-permission on the basis of a comparison result of the history information comparison unit 10060. The registered information update unit 10080 updates the registered information held in the registered information accumulation unit 10020, on the basis of the judgment result of the update permission or non-permission judgment unit 10070.

In an example, the inquiry input unit 10010 is constructed from an image-taking device such as a camera and a video camera. Such a camera or a video camera is frequently employed especially in a case that the employed biological information is visual information such as a face, a silhouette, and a fingerprint. When the employed biological information is voice, a microphone or the like may be employed as the inquiry input unit 10010. When the biological information is a fingerprint or the like, a touch control sensor may be employed as the inquiry input unit 10010.

In an example, the registered information accumulation unit 10020 is constructed from a storage device such as a hard disk and a flash memory. The registered information accumulation unit 10020 may be a dedicated storage device or, alternatively, may be shared with another storage device. The registered information accumulation unit 10020 may be in a mode of accumulating biological information alone or, alternatively, may be in a form of being provided with a database or the like for recording attribute information such as the affiliation and the age of a person of target of the biological information.

Thus, the registered information accumulation unit 10020 serves as a person authentication dictionary (10020) for storing the biological information of the person of recognition target.

In an example, the biological information comparison unit 10030 is constructed from a central processing unit (CPU) in which a program has been installed that operates in accordance with a rule set forth in advance. The biological information comparison unit 10030 operates such as to directly compare the input information received from the inquiry input unit 10010 with the biological information accumulated in the registered information accumulation unit 10020 and thereby calculate the similarity. When the input from the inquiry input unit 10010 is media information such as an image and sound information, the biological information comparison unit 10030 may perform comparison after extracting biological information (a biological feature quantity) from the inputted media information. Further, when a certain accumulation mode is employed in the registered information accumulation unit 10020, the biological information comparison unit 10030 may perform comparison after performing processing also on the accumulation information accumulated in the registered information accumulation unit 10020.

In an example, the person judgment unit 10040 is constructed from a CPU in which a program operating in accordance with a rule set forth in advance is installed. The person judgment unit 10040 operates such that, when the similarity calculated by the biological information comparison unit 10030 is greater than a threshold set forth in advance, the target person is judged as identical to the person read from the corresponding registered information accumulation unit 10020 and then compared. The person judgment unit 10040 may operate such as to display the name of the person in cooperation with an output device. Further, in a service in which a particular person is to be detected in advance, the person judgment unit 10040 may perform the operation of generating sound in case of being found, in cooperation with an output device such as an alarm.

Further, the biological information comparison unit 10030 and the person judgment unit 10040 may operate such that biological information of a plurality of persons accumulated in the registered information accumulation unit 10020 is read successively, then the similarity to the biological information from the inquiry input is measured of each, and then the person judgment unit 10040 outputs as the target person a person having the highest similarity in the registration dictionary accumulation unit 10020.

In an example, the inquiry history accumulation unit 10050 is constructed from a storage device such as a hard disk and a flash memory. The inquiry history accumulation unit 10050 may be a dedicated storage device or, alternatively, may be shared with another storage device. The inquiry history accumulation unit 10050 may be in a mode of accumulating intact the inputted media information such as an image and a video or, alternatively, in a mode of extracting biological information in advance and then accumulating the extracted biological information alone. The inquiry history accumulation unit 10050 may operate such as to store time information in accordance with the biological information and then accumulate the inquiry information within a fixed term alone. Alternatively, the inquiry history accumulation unit 10050 may operate such as to, when a new input has been received, delete the oldest biological information and thereby always hold a fixed number of pieces alone.

In other words, the inquiry input unit 10010 serves as a storage unit (10010) for storing and accumulating the inquiry biological information received within a predetermined term, into the history accumulation unit (10050).

In an example, the history information comparison unit 10060 is constructed from a CPU in which a program operating in accordance with a rule set forth in advance is installed. The history information comparison unit 10060 operates such as to receive from the inquiry history accumulation unit 10050 the inquiry biological information having been inputted until that time and then calculate the similarity of the biological information. When the information accumulated in the inquiry history accumulation unit 10050 is media information such as an image and sound information, the history information comparison unit 10060 performs comparison after extracting biological information (a biological feature quantity) from the inputted media information. The history information comparison unit 10060 may operate such as to calculate the similarity for all combinations of the accumulated biological information or, alternatively, may operate such as to calculate the similarity for a plurality of combinations selected from all combinations.

The CPU may serve as the history information comparison unit 10060 alone or, alternatively, may serve also as other units such as the biological information comparison unit 10030.

At the time of calculation of the similarity, in some cases, a first similarity of second biological information B relative to first biological information A has a different value from a second similarity of the first biological information A relative to the second biological information B. In this case, the history information comparison unit 10060 may calculate a mutual similarity between the pair of the biological information pieces A and B from the first similarity of the second biological information B relative to the first biological information A and the second similarity of the first biological information A relative to the second biological information B, and then may employ it as a substitute. An example to this is to take the arithmetic means of the two. Alternatively, another method may be employed.

Thus, the history information comparison unit 10060 serves as a generation unit (10060) for measuring the similarity of the inquiry biological information pieces accumulated in the inquiry history accumulation unit (10050) and then generating the similarity of each pair of biological information pieces.

In an example, the update permission or non-permission judgment unit 10070 is constructed from a CPU in which a program operating in accordance with a rule set forth in advance is installed. The update permission or non-permission judgment unit 10070 operates such as to, when the similarity of a pair of biological information pieces calculated by the history information comparison unit 10060 is greater than a threshold set forth in advance, perform counting, then measure the number of pairs having a similarity higher than the threshold set forth in advance in the similarity calculation performed by the history information comparison unit 10060, and then, when the number is greater than a threshold, perform judgment of update. At the time of judgment, the threshold may be the number of occasions of appearance of pairs having a high similarity, or, alternatively, may be the probability of appearance. The update permission or non-permission judgment unit 10070 may be provided with an input device and then constructed such that the threshold can be set up by a user or a system administrator.

The CPU may serve as the update permission or non-permission judgment unit 10070 alone or, alternatively, may serve also as other units such as the biological information comparison unit 10030.

In an example, the registered information update unit 10080 is constructed from a CPU in which a program operating in accordance with a rule set forth in advance is installed. The registered information update unit 10080 receives from the update permission or non-permission judgment unit 10070 the pair of biological information pieces having a high similarity and then updates the dictionary information in the registered information accumulation unit 10020 by using the corresponding biological information accumulated in the inquiry history accumulation unit 10050. At the time of update, the registered information update unit 10080 may operate such as to select one of the plurality of biological information pieces and then replace the oldest data of the dictionary information or, alternatively, may operate such as to perform replacement by using the plurality of biological information pieces. Alternatively, values may be changed by arithmetic operations.

The CPU may serve as the registered information update unit 10080 alone or, alternatively, may serve also as other units such as the biological information comparison unit 10030.

Thus, the combination of the update permission or non-permission judgment unit 10070 and the registered information update unit 10080 serves as an update section (10070, 10080) for updating the person authentication dictionary (10020) on the basis of the pair of biological information pieces judged as having a high similarity.

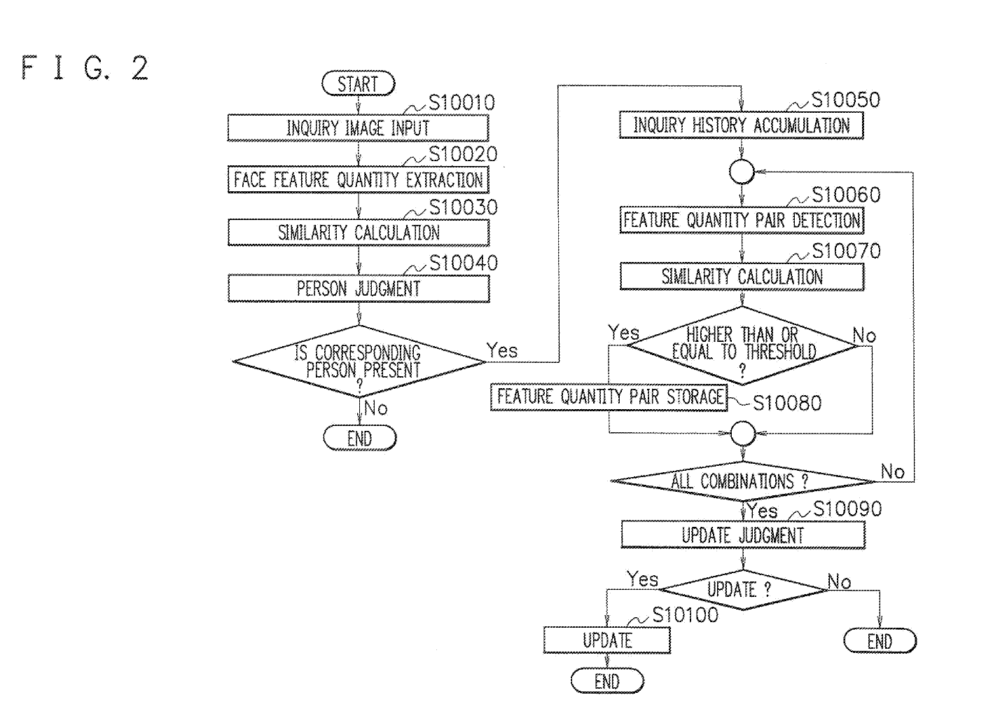

Next, with reference to the flow charts of FIGS. 1 and 2, the flowing description is given for an example of overall operation of the person authentication apparatus according to the first embodiment of the present invention.

Here, it is premised that the biological information is face feature information of a person, the input information is a static image obtained by a camera, and the information accumulated as the registered information is a face feature quantity extracted from the static image.

A large number of methods have been proposed as extraction methods for a face feature quantity from a static image and as similarity calculation methods employing a face feature quantity. An example is the extraction method for a face feature quantity and the similarity calculation method employing the face feature quantity described in Patent Document 7 given above. In the feature quantity extraction and the similarity calculation, a quantity other than the feature quantity described in Patent Document 7 may be employed as long as a face feature quantity can be extracted from the contents such as an image and a video and then the similarity or the degree of agreement can be measured.

Description of an example of operation of the person authentication apparatus according to the first embodiment of the present invention is given on a premise that the biological information is face feature information. However, a similar flow is applicable as long as extraction of biological information can be performed and then the similarity or the degree of agreement can be calculated between the accumulated biological information pieces. Thus, for example, it is obvious that the person authentication apparatus according to the first embodiment of the present invention can be applied directly also to biological information such as a fingerprint image, iris information, a shape-of-palm image, a finger image, and speech information.

In the registered information accumulation unit 10020, a face feature quantity (a biological information piece) of a user is registered in advance in a manner of being related to the ID of the user. At the time of accumulation of the registered information, a face region may be extracted from a photograph of the user and then information extracted on the basis of a visual feature of the extracted face region may be employed. This can be achieved by extraction using the biological information comparison unit 10030 in the same method as the extraction of a feature quantity from an inquiry image. Alternatively, the extraction and accumulation may be achieved by using another method.

The face feature quantity (the biological information) to be registered in the registered information accumulation unit 10020 may be a face feature quantity (a biological information piece) of particular one person set forth in advance. Then, the inquiry to be inputted may be judgment whether a person is identical to the particular person set forth in advance. Alternatively, the face feature quantity (the biological information) to be registered in the registered information accumulation unit 10020 may be face feature quantities (biological information pieces) of a plurality of persons. Then, the inquiry to be inputted may be judgment which person corresponds to the particular person. Here, the following description is given on a premise that face feature quantities (biological information pieces) of a plurality of persons are registered.

First, an inquiry image is inputted through the inquiry input unit 10010 (step S10010).

The biological information comparison unit 10030 analyzes the inquiry image so as to extract a face feature quantity (a biological information piece) from the input image for the purpose of image comparison (step S10020). In an example, the extraction of the feature quantity may be performed by the method described in Patent Document 7 given above. However, another method may be employed. Further, when image comparison is directly performed without extraction of the feature quantity, the present step may be skipped. In this case, images are accumulated as the registered information.

The biological information comparison unit 10030 successively reads the face feature quantities (the biological information pieces) accumulated in the registered information accumulation unit 10020 and then calculates the similarity to the face feature quantity in the above-mentioned inquiry image (step S10030). In an example, the calculation of the similarity may be performed by the method described in Patent Document 7 given above. However, another method may be employed.

The person judgment unit 10040 receives the similarity to each face feature quantity (biological information piece) calculated by the biological information comparison unit 10030. Then, when the similarity is higher than a threshold set forth in advance, the person judgment unit 10040 judges that the target person is identical to the corresponding person, then extracts a user ID associated with the face feature quantity (the biological information) from the registered information accumulation unit 10020, and then output it (step S10040).

As a result of comparison, in the judgment of presence or absence of a corresponding person, when no corresponding person has been found, update of the person authentication dictionary (10020) by using the inquiry input is not to be performed. Thus, the processing is terminated. When a corresponding person has been found, the inquiry input unit 10010 stores and accumulates the corresponding user ID and the face feature quantity (the biological information) into the inquiry history accumulation unit 10050 (step S10050).

Thus, the storage unit (10010) stores and accumulates the inquiry biological information for each person of authentication target, into the inquiry history accumulation unit (10050).

The history information comparison unit 10060 detects a pair of combinable face feature quantities (biological information pieces) among the face feature quantities (the biological information pieces) having the same user ID as the user ID of the person judged as identical to the person contained in the inquiry image by the person judgment unit 10040, among the face feature quantities (the biological information pieces) accumulated in the inquiry history accumulation unit 10050 (step S10060). Then, the history information comparison unit 10060 calculates the similarity between the face feature quantities (the biological information pieces) for the detected pair of face feature quantities (biological information pieces) (step S10070) and then judges whether the calculated similarity is greater than a threshold set forth in advance. When the calculated similarity is greater than or equal to the threshold, the history information comparison unit 10060 stores the pair of face feature quantities (biological information pieces) as a pair of face feature quantities having a high similarity (step S10080).

Here, the threshold may have the same value as the threshold adopted in the biological information comparison unit 10030 or, alternatively, may have a different value. When a value higher than the threshold adopted in the biological information comparison unit 10030 is adopted, those having a high similarity are extracted alone. Thus, an advantage is obtained that reliability is increased in the update. The person authentication apparatus performs the processing of steps S10060 to S10080 onto all pairs of face feature quantities (biological information pieces).

As such, for each target person, the generation unit (10060) measures the similarity of the inquiry biological information pieces accumulated in the inquiry history accumulation unit (10050) and then generates the similarity of each pair of biological information pieces.

The update permission or non-permission judgment unit 10070 receives the stored result of the pairs of similar face feature quantities (biological information pieces) from the history information comparison unit 10060 and then judges whether update is to be performed (step S10090). In an example, the update permission or non-permission judgment unit 10070 calculates the number of pairs having a similarity higher than a threshold and then, when the number is greater than a value set forth in advance, judges that a large number of face feature quantities (biological information pieces) are similar and hence update is to be performed. The update permission or non-permission judgment may be not judgment based on the number alone. That is, normalization by the total number of pairs of face feature quantities (biological information pieces) may be performed.

At step S10090, when it is judged that update is to be performed, the registered information update unit 10080 updates the registered information registered in the registered information accumulation unit 10020 (step S10100) and then terminates the processing. In an example, the registered information update unit 10080 adopts one from the group of face feature quantities (biological information pieces) constituting the pairs of face feature quantities (biological information pieces) judged as having a high similarity, and then replaces the face feature quantity (the biological information) accumulated in the registered information accumulation unit 10020. Further, when the registered information accumulation unit 10020 accumulates a plurality of face feature quantities (biological information pieces), the registered information update unit 10080 may perform the processing of newly adding a face feature quantity (a biological information piece). Further, in place of simply adopting one from the face feature quantities (the biological information pieces), the registered information update unit 10080 may adopt one selected most frequently as a pair among the group of face feature quantities (biological information pieces) constituting the pairs of face feature quantities (biological information pieces) judged as having a high similarity. Further, in spite of one face feature quantity (biological information piece), the registered information update unit 10080 may add or replace a plurality of face feature quantities (biological information pieces). When the processing of arithmetic mean or the like is achievable, the arithmetic mean of the face feature quantities (biological information pieces) may be adopted in the update.

As such, when the total number of pairs of similar biological information pieces is greater than or equal to a number set forth in advance, the update section (10070, 10080) updates the person authentication dictionary (10020) by using at least one biological information piece constituting the pair of biological information pieces judged as having a high similarity.

When the absence of update has been concluded, the processing is terminated immediately.

When the person authentication apparatus according to the first embodiment is to be constructed from an electronic device, the person authentication apparatus may be realizable by a computer operating under program control. Although not shown in a figure, as known widely, a computer of this kind includes: an input device for receiving input of data; a data processing device; an output device for outputting a processing result from the data processing device; and an auxiliary storage device serving as various databases. Then, the data processing device is constructed from: a read-only memory (ROM) for storing a program; a random-access memory (RAM) serving as a work memory for temporarily storing data; and a central processing unit (CPU) for processing the data stored in the RAM in accordance with the program stored in the ROM.

In this case, the input device serves as the inquiry input unit 10010. The data processing device serves as the biological information comparison unit 10030, the person judgment unit 10040, the history information comparison unit 10060, the update permission or non-permission judgment unit 10070, and the registered information update unit 10080. Then, the auxiliary storage device serves as the registered information accumulation unit 10020 and the inquiry history accumulation unit 10050.

In other words, each section of the person authentication apparatus according to the first embodiment may be realized by employing a combination of hardware and software. In a mode in which hardware and software are combined, the hardware such as a control section (the CPU) is caused to operate in accordance with a person authentication program stored in the ROM so that each section is realized as diverse means. Further, the person authentication program may be distributed in a manner of being recorded on a recording medium. The person authentication program recorded on the recording medium is read onto a memory through a cable, by wireless, or through the recording medium itself and then causes the control section and the like to operate. Here, examples of the recording medium include an optical disk, a magnetic disk, a semiconductor memory device, and a hard disk.

In another form of expression, the first embodiment given above is as follows. An information processing device serving as the person authentication apparatus can be realized when the control section (the CPU) operates as the biological information comparison unit 10030, the person judgment unit 10040, the history information comparison unit 10060, the update permission or non-permission judgment unit 10070, and the registered information update unit 10080 in accordance with the person authentication program stored in the ROM.

Next, the effect of the person authentication apparatus according to the first embodiment of the present invention is described below.

Update is performed only when, in the inquiry images presented as targets of inquiry within a particular term, the number of pairs of face feature quantities judged as having a high similarity is greater than or equal to a fixed number. By virtue of this, only when there is a face feature quantity stably observed within the particular term, update can be performed by using the face feature quantity. Thus, an influence from a fluctuation in the inquiry image associated with a transitory input fluctuation, from a short-term change in the target, or from the like can be excluded. Accordingly, the object of the invention can be achieved that the image is updated on the basis of a face feature quantity observed in a medium to long term including a temporal change such as aging. Further, an influence from a short-term change in the target or the like can be excluded. Thus, another effect can also be obtained that the quality of the dictionary information can be maintained.

In the first embodiment for implementing the present invention, from the perspective of a person authentication apparatus, the biological information comparison unit 10030 and the person judgment unit 10040 have been arranged. However, from the perspective of update of the dictionary information accumulated in the registered information accumulation unit 10020, it should be noted that the biological information comparison unit 10030 and the person judgment unit 10040 are not indispensable and hence the other units alone are sufficient for the implementation.

In this case, as described above, the registered information accumulation unit 10020 serves as the person authentication dictionary (10020). Thus, a person authentication apparatus without the biological information comparison unit 10030 and the person judgment unit 10040 serves as a person authentication dictionary update apparatus.

In a mode in which hardware and software are combined, the hardware such as a control section (the CPU) is caused to operate in accordance with a person authentication dictionary update program stored in the ROM so that each section is realized as diverse means. An information processing device serving as the person authentication dictionary update apparatus can be realized when the control section (the CPU) operates as the history information comparison unit 10060, the update permission or non-permission judgment unit 10070, and the registered information update unit 10080 in accordance with the person authentication dictionary update program stored in the ROM.

Further, the person authentication dictionary update program may be distributed in a manner of being recorded on a recording medium. The person authentication program recorded on the recording medium is read onto a memory through a cable, by wireless, or through the recording medium itself and then causes the control section and the like to operate. Here, examples of the recording medium include an optical disk, a magnetic disk, a semiconductor memory device, and a hard disk.

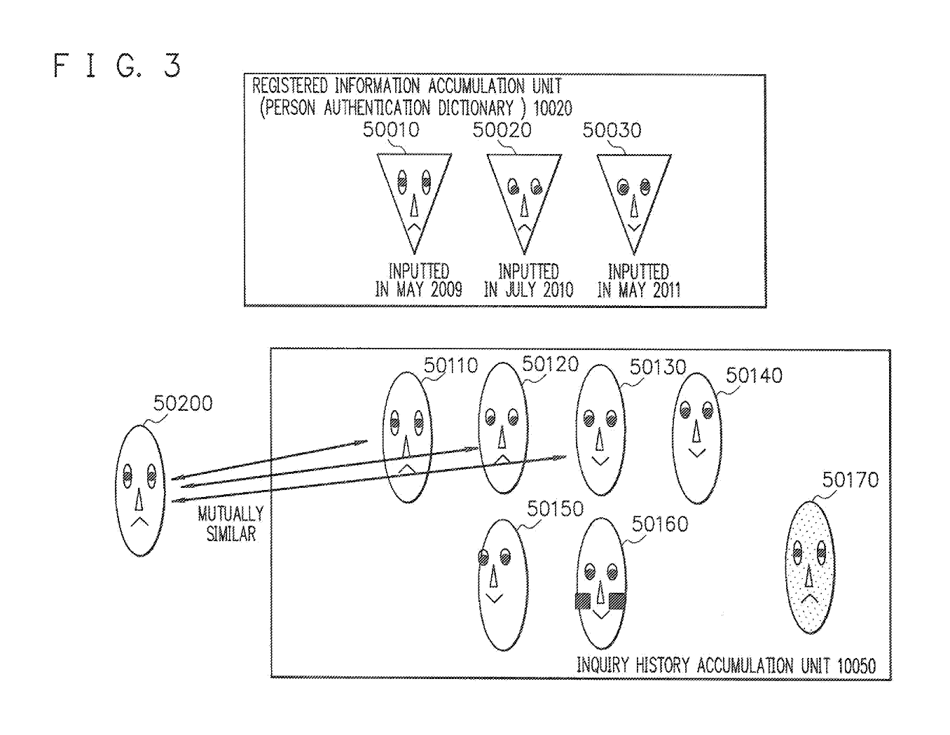

Next, an example of operation of the person authentication apparatus according to the first embodiment of the present invention is described below with reference to FIG. 3.

Face feature quantities (biological information pieces) stored in the registered information accumulation unit 10020 for the purpose of authentication of a particular person are referred to as a first to a third face feature quantity (biological information piece) 50010, 50020, and 50030. It is premised that these face feature quantities (the biological information pieces) have been acquired as dictionary information into the registered information accumulation unit 10020 in May 2009, July 2010, and May 2011, respectively. Here, for simplicity of description, image display is adopted. However, in practice, face feature quantities (the biological information pieces) may be stored. The accumulated face feature quantities (biological information pieces) do not necessarily agree completely. That is, they are different in the environment or the direction of image taking, the facial expression, or the like. Further, they contain a temporal change of aging or the like having occurred from 2009 to 2011.

The images (the biological information pieces) inputted after that and then registered in the inquiry history accumulation unit 10050 are referred to as a first to a seventh registered image (biological information pieces) 50110, 50120, 50130, 50140, 50150, 50160, and 50170. In FIG. 3, it is premised that the target person has gained a body weight and the roundness of the face has increased during the term. However, it is premised that the positional relations between the eyes, the nose, and the mouth and their shapes or the like are similar and hence are similar to any one of the first to the third face feature quantity (biological information pieces) 50010, 50020, and 50030 accumulated as the dictionary so that identicalness to the target person can be judged. At that time, the inquiry history accumulation unit 10050 contains various types of fluctuations caused by the input situation. An example is such that: the camera used in image taking was located downward of the face (the fourth registered image 50140); the face was turned right (the fifth registered image 50150); painting was performed in the face (the sixth registered image 50160); different illumination was employed at the time of image taking (the seventh registered image 50170); and the like. In addition, various types of face feature quantities (biological information pieces) including a difference in the facial expression and the like are accumulated in the inquiry history.

Because of such fluctuations, although identicalness to the target person can be recognized on the basis of the similarity to the registered information accumulation unit 10020, only three pairs (50110, 50120), (50110, 50130), and (50120, 50130) are concluded as similar on the basis of the similarity of the face feature quantities (the biological information pieces) constituting a pair with the face feature quantity (the biological information piece) in the inside of the inquiry image in which the threshold has been set more strict. In a case that the threshold for the number of pairs for update is premised to be “5”, since there are only three pairs of similar face feature quantities (biological information pieces), update processing is not performed.

Here, an inquiry image (a biological information piece) 50200 is premised to be inputted newly. The face feature quantity (the biological information piece) extracted from the inquiry image has been obtained on the basis of image taking performed in a relatively stable situation concerning the direction, the facial expression, the illumination, and the like. Thus, the input inquiry image 50200 is similar to the first to the third registered image 50110, 50120, and 50130. As a result, the number of pairs of similar face feature quantities (biological information pieces) in the inside of the inquiry history accumulation unit 10050 increases from “3” to “6” and thereby exceeds the threshold “5” for the number of pairs of face feature quantities (biological information pieces) having been set forth in advance for update. Thus, the registered information update unit 10080 performs update of the registered information accumulation unit (the person authentication dictionary) 10020 by using one or a plurality of face feature quantities (biological information pieces) selected from the first to the third registered image 50110, 50120, and 50130 and the input inquiry image 50200 which are components of the pairs exceeding the threshold.

In an example, the registered information update unit 10080 performs the processing of replacing with the input inquiry image 50200 the first face feature quantity 50010 having been inputted at the earliest time. Alternatively, the registered information update unit 10080 may adopt a method of measuring the similarity between the input inquiry image 50200 and the first to the third face feature quantity 50010, 50020, and 50030 and then replacing one having the highest similarity or replacing one having the lowest similarity. Further, the registered information update unit 10080 may adopt a method of measuring the similarity between (50110, 50120, 50130, 50200) and (50010, 50020, 50030) which are similar, then calculating the average similarity, and then replacing one having the highest average similarity or one having the lowest average similarity. The methods of update presented above are exemplary at all points and it is obvious that a general method of updating an existing feature quantity by using a newly adopted feature quantity may be applied.

As such, update is performed only when the number of pairs of face feature quantities having a high similarity exceeds a fixed number. By virtue of this, update can be performed on the basis of the stable face feature quantity in which fluctuations are reflected on the basis of the medium-to-long term feature.

The number of images accumulated in the inquiry history accumulation unit 10050 is maintained at constant, that is, when a new face feature quantity (50200, in this example) is inputted, the face feature quantity (the fourth registered image 50140, tentatively in this example) inputted at the earliest time is deleted from the inquiry history accumulation unit 10050. By virtue of this, the registered information accumulation unit (the person authentication dictionary) 10020 can be updated only when a stable fixed feature has been obtained within a particular term.

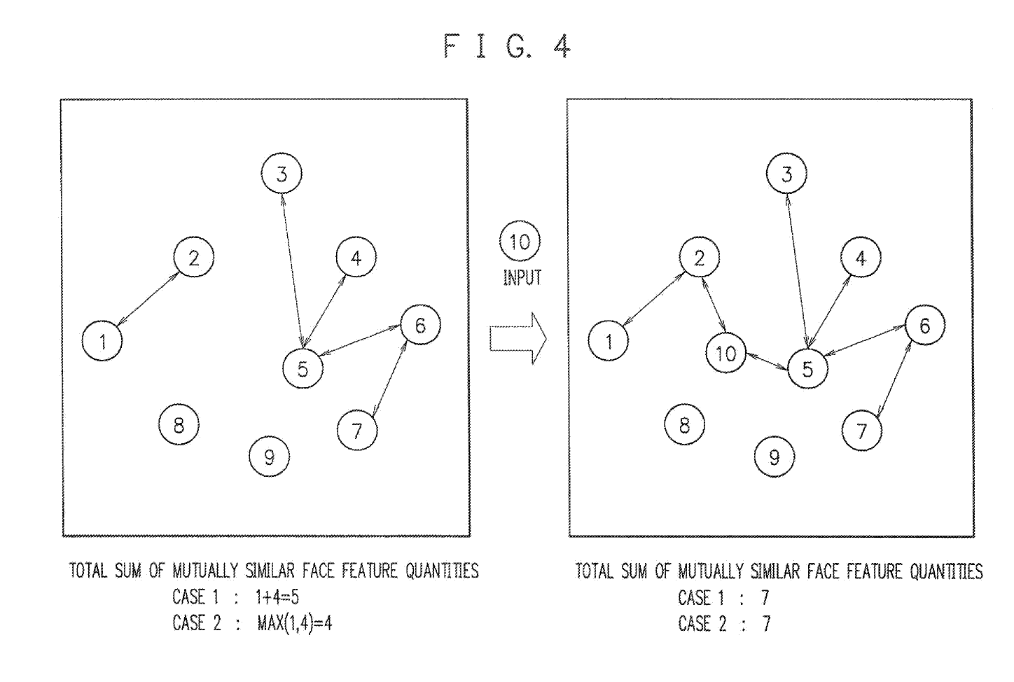

FIG. 4 is a diagram schematically describing a variation of judgment for a pair of similar face feature quantities (biological information pieces) in the inside of the inquiry history accumulation unit 10050.

In FIG. 4, from the perspective of a pair of face feature quantities (biological information pieces) having a high similarity, two groups (1, 2) and (3, 5) (4, 5) (5, 6) (6, 7) are formed. In this case, the number of pairs of face feature quantities (biological information pieces) having a high similarity may be defined as “5” which is the total sum of the total number 1 of pairs for the group (1, 2) and the total number 4 of pairs for the groups (3, 5) (4, 5) (5, 6) (6, 7) (referred to as case 1). Alternatively, the number of pairs of face feature quantities having a high similarity may be defined as “4” which is the maximum number of pairs among the groups of pairs of face feature quantities (biological information pieces) having a high similarity (referred to as case 2).

When a newly inputted inquiry image 10 is similar to 2 and 5, regardless of case 1 or case 2, the number of pairs of face feature quantities (biological information pieces) having a high similarity becomes “7”. In case 1, since the total sum is calculated, the total number of pairs of face feature quantities having a high similarity increases when several input patterns are present. In contrast, case 2 has a feature that even when several input patterns are present, the number of pairs of similar face feature quantities (biological information pieces) does not increase. In accordance with the situation that update is desired, the operator such as a system administrator can set up the number of pairs of face feature quantities (biological information pieces) having a high similarity.

Thus, when case 2 is adopted, when a maximum value of biological information pieces adjacent to each other from the perspective of a pair of similar biological information pieces is greater than or equal to a number set forth in advance, the update section (10070, 10080) updates the person authentication dictionary (10020) by using at least one biological information piece among the biological information pieces giving the maximum value of biological information pieces adjacent to each other.

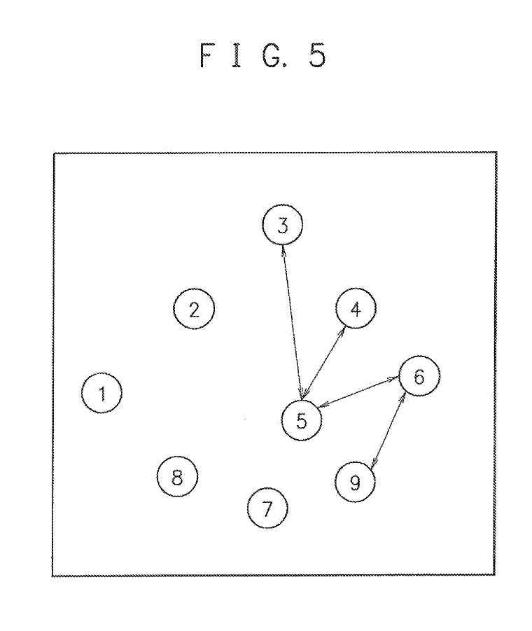

FIG. 5 is a diagram schematically describing a selection method for a face feature quantity (a biological information piece) used in update in the inside of the inquiry history accumulation unit 10050.

In FIG. 5, when one image used for update is to be selected, any one can be selected from 3, 4, 5, 6, and 9. When inquiry is performed in the order from 1 to 9, methods of selecting one are as follows.

Face feature quantity on which inquiry was performed at the earliest time: 3

Face feature quantity on which inquiry was performed most recently: 9

Face feature quantity most frequently participating similarity pairs: 5

Further, in addition to these, various kinds of methods can be employed like a method of arbitrarily performing selection and a method of selecting any one in the pair of face feature quantities (biological information pieces) having the highest similarity among the pairs.

### Second Embodiment

Next, a second embodiment for implementing the present invention is described below with reference to the drawings.

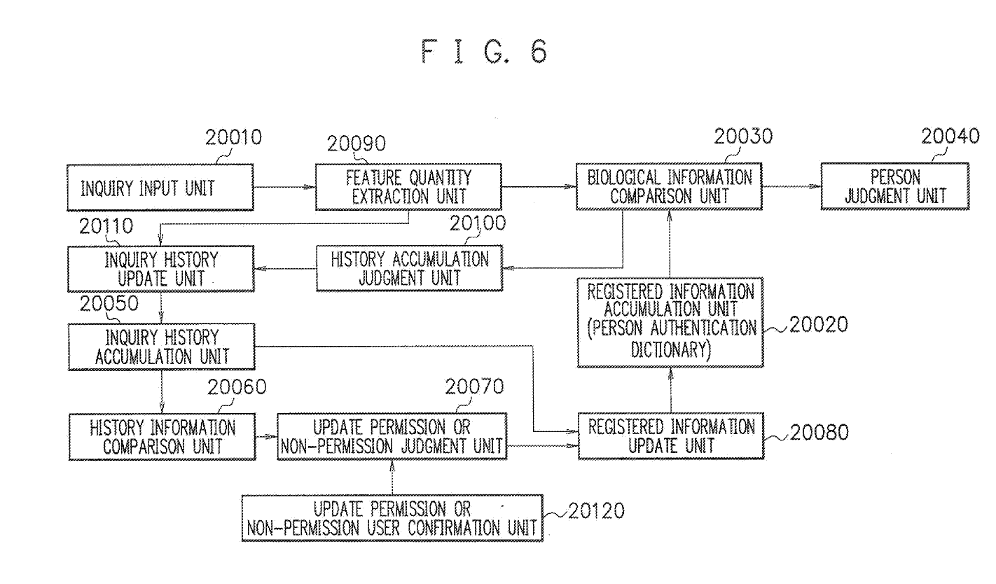

Referring to FIG. 6, a person authentication apparatus according to the second embodiment of the present invention is constructed from an inquiry input unit 20010, a registered information accumulation unit 20020, a feature quantity extraction unit 20090, a biological information comparison unit 20030, a person judgment unit 20040, an inquiry history accumulation unit 20050, a history accumulation judgment unit 20100, an inquiry history update unit 20110, a history information comparison unit 20060, an update permission or non-permission judgment unit 20070, an update permission or non-permission user confirmation unit 20120, and a registered information update unit 20080.

The inquiry input unit 20010 receives input of biological information of a person for the purpose of recognition (authentication). The registered information accumulation unit (the person authentication dictionary) 20020 stores in advance, as registered information, a feature quantity of biological information of a person of recognition target. The feature quantity extraction unit 20090 extracts the feature quantity (the biological information) of an object contained in the inquiry input inputted through the inquiry input unit 20010.

The biological information comparison unit 20030 calculates the similarity between the feature quantity of the biological information inputted from the feature quantity extraction unit 20090 and the feature quantity of the biological information held in the registered information accumulation unit (the person authentication dictionary) 20020, and then performs comparison. The person judgment unit 20040 identifies the target person on the basis of the similarity calculated by the biological information comparison unit 20030.

The inquiry history accumulation unit 20050 accumulates the feature quantity of the biological information of the inquiry input history. On the basis of the comparison result of the biological information comparison unit 20030, the history accumulation judgment unit 20100 judges whether the feature quantity in the inquiry input is to be accumulated. On the basis of the result of the history accumulation judgment unit 20100, the inquiry history update unit 20110 updates the inquiry history accumulated in the inquiry history accumulation unit 20050.

The history information comparison unit 20060 calculates a similarity between biological information pieces held in the inquiry history accumulation unit 20050. The update permission or non-permission judgment unit 20070 judges update permission or non-permission on the basis of a comparison result of the history information comparison unit 20060. At the time of the update permission or non-permission judgment, the update permission or non-permission user confirmation unit 20120 receives input of the judgment result of the user. The registered information update unit 20080 updates the registered information held in the registered information accumulation unit 20020, on the basis of the judgment result of the update permission or non-permission judgment unit 20070.

In FIG. 6, the inquiry input unit 20010, the registered information accumulation unit 20020, the biological information comparison unit 20030, the person judgment unit 20040, the inquiry history accumulation unit 20050, the history information comparison unit 20060, the update permission or non-permission judgment unit 20070, and the registered information update unit 20080 can respectively be realized by the same or almost the same configurations of the inquiry input unit 10010, the registered information accumulation unit 10020, the biological information comparison unit 10030, the person judgment unit 10040, the inquiry history accumulation unit 10050, the history information comparison unit 10060, the update permission or non-permission judgment unit 10070, and the registered information update unit 10080 in FIG. 1. Thus, their description is omitted.

The feature quantity extraction unit 20090 detects the biological information relevant to the person contained in the inquiry input inputted through the inquiry input unit 20010 and then extracts a feature quantity from the detected biological information. In an example, the feature quantity extraction unit 20090 is constructed from a CPU in which a program operating in accordance with a rule set forth in advance is installed. In a case that the input information is an image and the feature quantity is a face feature quantity, the feature quantity extraction unit 20090 may operate by employing the method described in Patent Document 7 given above. Various extraction methods for a fingerprint, an iris, a voice, and the like have been proposed and widely known in the public. Thus, the feature quantity extraction unit 20090 may be in the form of a CPU for operating in accordance with a program describing these methods or, alternatively, in the form of a circuit for realizing it.

On the basis of the comparison result of the biological information comparison unit 20030, the history accumulation judgment unit 20100 judges whether the feature quantity in the inquiry input is to be accumulated. In an example, the history accumulation judgment unit 20100 is constructed from a CPU in which a program operating in accordance with a rule set forth in advance is installed. For the purpose of history accumulation judgment, the history accumulation judgment unit 20100 may simultaneously include: storage means such as a memory for temporarily storing past comparison results; a sensor for judging the environment; and the like.

On the basis of the judgment result of the history accumulation judgment unit 20100, the inquiry history update unit 20110 updates the inquiry history information accumulated in the inquiry history accumulation unit 20050. In an example, the inquiry history update unit 20110 is constructed from a CPU in which a program operating in accordance with a rule set forth in advance is installed.

Thus, the combination of the inquiry input unit 20010, the feature quantity extraction unit 20090, the history accumulation judgment unit 20100, and the inquiry history update unit 20110 serves as a storage unit (20010, 20090, 20100, 20110) for, when it is judged that the similarity of received inquiry biological information calculated in the biological information comparison unit (20030) is higher than a predetermined similarity, storing and accumulating the received inquiry biological information into the inquiry history accumulation unit (20050) as the inquiry biological information of the corresponding person.

At the time of the update permission or non-permission judgment, the update permission or non-permission user confirmation unit 20120 receives input of the judgment result of the user. In an example, the update permission or non-permission user confirmation unit 20120 can be realized by a terminal provided with a display for displaying a first result of update permission or non-permission judgment and with an input device such as a keyboard and a mouse.

That is, the update permission or non-permission user confirmation unit 20120 serves as a confirmation unit (20120) for, when inquiry biological information used for update is selected, confirming to the user or the administrator the presence or absence of update.

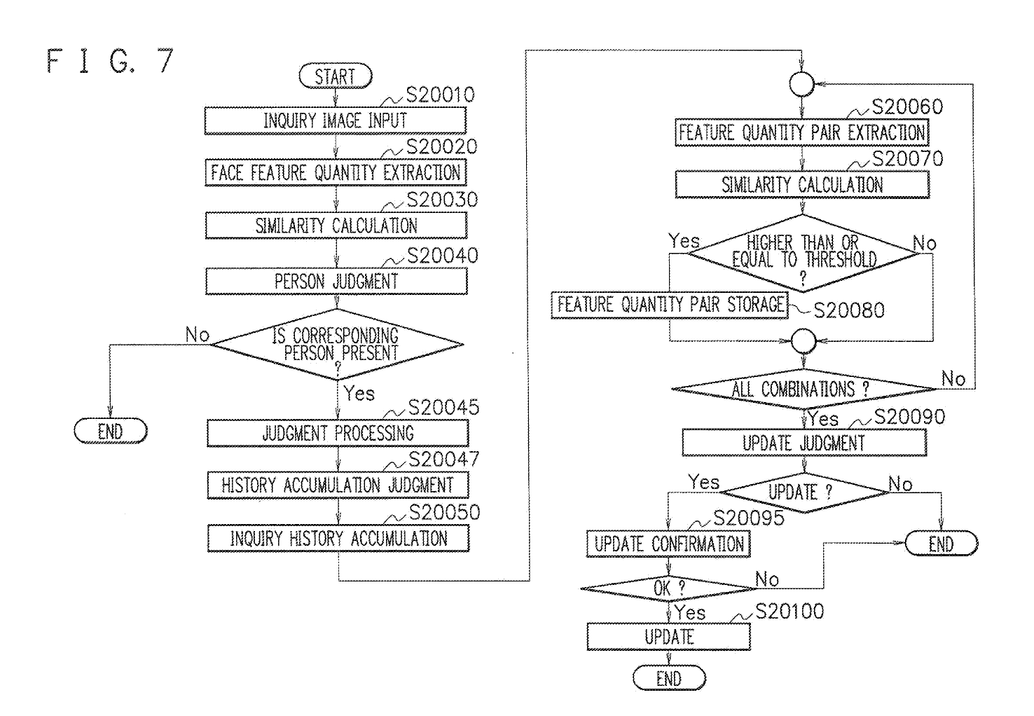

Next, with reference to the flow charts of FIGS. 6 and 7, the flowing description is given for an example of overall operation of the person authentication apparatus according to the second embodiment of the present invention.

Similarly to the description of the first embodiment given above, description of an example of operation of the person authentication apparatus according to the second embodiment of the present invention is given on a premise that the input information is an image of a video, a camera, or the like and that the biological information is face feature information. However, the person authentication apparatus according to the second embodiment of the present invention can be realized by a similar flow as long as biological information extraction from the input information can be executed and the similarity or the degree of agreement can be calculated between the accumulated biological information pieces. For example, it is obvious that the present apparatus can be applied directly also to biological information such as a fingerprint image, iris information, a shape-of-palm image, a finger image, and speech information.

In the registered information accumulation unit (the person authentication dictionary) 20020, the ID of the user and the face feature quantity extracted in advance are registered in advance in a manner of being related to each other. At the time of accumulation of the registered information, a face region may be detected from a photograph of the user and then information extracted on the basis of a visual feature of the detected face region may be employed as the face feature quantity. This can be achieved by extraction using the feature quantity extraction unit 20090 in the same method as the extraction of a feature quantity from an inquiry image. Alternatively, the extraction and accumulation may be achieved by using another method.

The face feature quantity (the biological information) to be registered in the registered information accumulation unit (the person authentication dictionary) 20020 may be a face feature quantity (a biological information piece) of particular one person set forth in advance. Then, the inquiry to be inputted may be judgment whether a person is identical to the particular person set forth in advance. Alternatively, the face feature quantity (the biological information) to be registered in the registered information accumulation unit (the person authentication dictionary) 20020 may be face feature quantities (biological information pieces) of a plurality of persons. Then, the inquiry to be inputted may be judgment which person corresponds to the particular person. In the former case, for example, the present apparatus can be used for unlocking of a portable phone, a safe, or the like owned by an individual person. In the latter case, the present apparatus can be applied to entering and exiting administration in a particular building or the like. Further, together with the ID of the user, the registered information accumulation unit (the person authentication dictionary) 20020 may store, in advance, other attribute information such as the address, the name, the age, and the annual income and then may output the attribute information of the person of comparison, when necessary. The following description is given on a premise that face feature quantities (biological information pieces) of a plurality of persons are registered in the registered information accumulation unit (the person authentication dictionary) 20020.

First, an inquiry image is inputted through the inquiry input unit 20010 (step S20010).

Then, the feature quantity extraction unit 20020 analyzes the inquiry image so as to extract a face feature quantity from the input image for the purpose of image comparison (step S20020). In an example, the extraction of the feature quantity may be performed by the method described in Patent Document 7 given above. However, another method may be employed. Methods of detecting a person from an image are widely known as face detection techniques. Thus, at the time of person detection, any suitable one of these methods is adopted. In a broad sense of the feature quantity, image information may be utilized intact. In this case, the processing of step S20020 becomes region extraction alone or, alternatively, becomes only the confirmation of presence or absence of detection.

The biological information comparison unit 20030 successively reads the face feature quantities (the biological information pieces) accumulated in the registered information accumulation unit (the person authentication dictionary) 20020 and then calculates the similarity to the face feature quantity (the biological information) in the inquiry image extracted by the feature quantity extraction unit 20090 (step S20030). In an example, the calculation of the similarity may be performed by the method described in Patent Document 7 given above. However, another method may be employed.

The person judgment unit 20040 receives the similarity to each face feature quantity (biological information piece) calculated by the biological information comparison unit 20030. Then, when the similarity is higher than a threshold set forth in advance, the person judgment unit 20040 judges that the target person is identical to the corresponding person (step S20040). Then, when the correspondence person has been authenticated, the person judgment unit 20040 reads the user ID and the attribute information related to the face feature quantity (the biological information piece) from the registered information accumulation unit (the person authentication dictionary) 20020 and then outputs them (step S20045). In addition to the output of the ID and the attribute information, the person judgment unit 20040 may perform associated processing such as device unlocking and entrance processing.

As a result of comparison, in the judgment of presence or absence of a corresponding person, when no corresponding person has been found, update of the person authentication dictionary 20020 by using the inquiry input is not to be performed. Thus, the processing is terminated.

On the basis of the comparison result of the biological information comparison unit 20030, for the person identified by the comparison processing, the history accumulation judgment unit 20100 judges whether the feature quantity in the inquiry input is to be accumulated (step S20047). The history accumulation judgment unit 20100 has identified a person on the basis of the comparison processing. However, in a case that the inputted person is identified on the basis of input of attribute information such as an ID and a name accumulated in the registered information accumulation unit 20020, update may be performed without depending on the result of comparison processing.

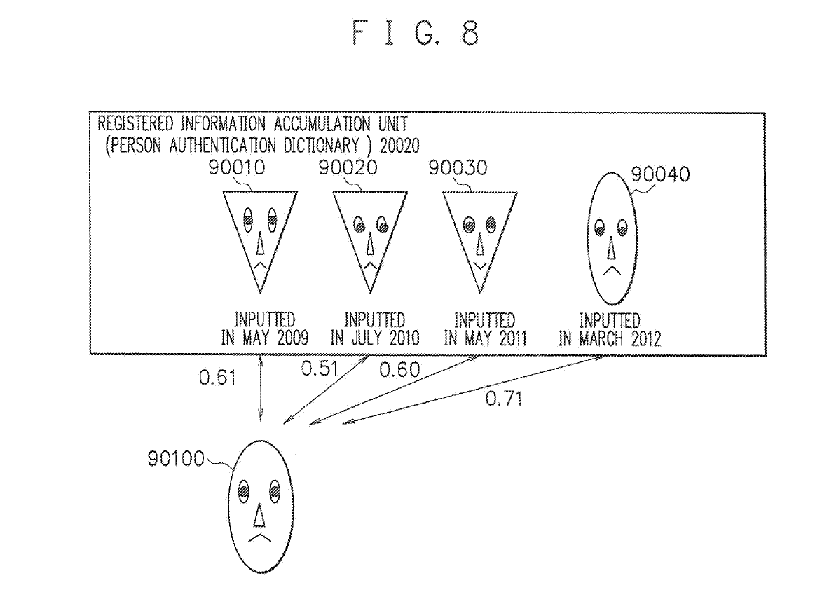

As a criterion for the judgment whether the feature quantity in the inquiry input is to be accumulated, various methods can be adopted. FIG. 8 schematically shows an example. It is premised that four kinds (90010, 90020, 90030, 90040) of face feature quantities (biological information pieces) of the persons are accumulated in the registered information accumulation unit (the person authentication dictionary) 20020. Here, the four kinds of face feature quantities (biological information pieces) are referred to as a first to a fourth face feature quantity (biological information pieces) 90010, 90020, 90030, and 90040. In general, the face feature quantity (the biological information piece) is a symbol extracted from an image and hence is difficult to be illustrated. However, for the purpose of description, they are schematically shown in the figure. In this example, it is premised that four kinds of face feature quantities (biological information pieces) are accumulated. Instead, one kind or, alternatively, ten or more kinds may be employed.

It is premised that the similarities between the face feature quantity 90100 extracted from the inquiry image and the first to the fourth face feature quantity 90010, 90020, 90030, and 90040 are “0.61”, “0.51”, “0.60”, and “0.71”, respectively. In a case that the threshold for authentication as the person is premised to be “0.6”, the first, the third, and the fourth face feature quantity 90010, 90030, and 90040 satisfy the condition. Thus, the comparison result of FIG. 8 becomes successful authentication.

At that time, judgment whether the extracted face feature quantity 90100 is to be accumulated into the inquiry history accumulation unit 20050 can be realized by using the comparison scores relative to the first to the fourth face feature quantity 90010, 90020, 90030, and 90040. In an example, following setup may be employed. That is, when at least one among the comparison results is lower than the judgment threshold “0.6”, there is a possibility that the second face feature quantity 90020 is not suitable as the dictionary. Thus, in a case that the inquiry face feature quantity is not transitory and is a medium-to-long term feature, update of the dictionary becomes necessary. Accordingly, the data may be added to the history for the purpose of confirmation of a medium-to-long term property. Further, another setup may be employed that when the similarities to all face feature quantities are lower than a higher threshold “0.80” set forth in advance, since there is no one completely agreeing with the inquiry input, the data may be added to the history.

In this case, when the similarity of the received inquiry biological information calculated in the biological information comparison unit (20030) is higher than a first similarity set forth in advance and lower than a second similarity set forth in advance, the storage unit (20010, 20090, 20100, 20110) stores and accumulates the received inquiry biological information into the inquiry history accumulation unit (20050) as biological information of the corresponding person.

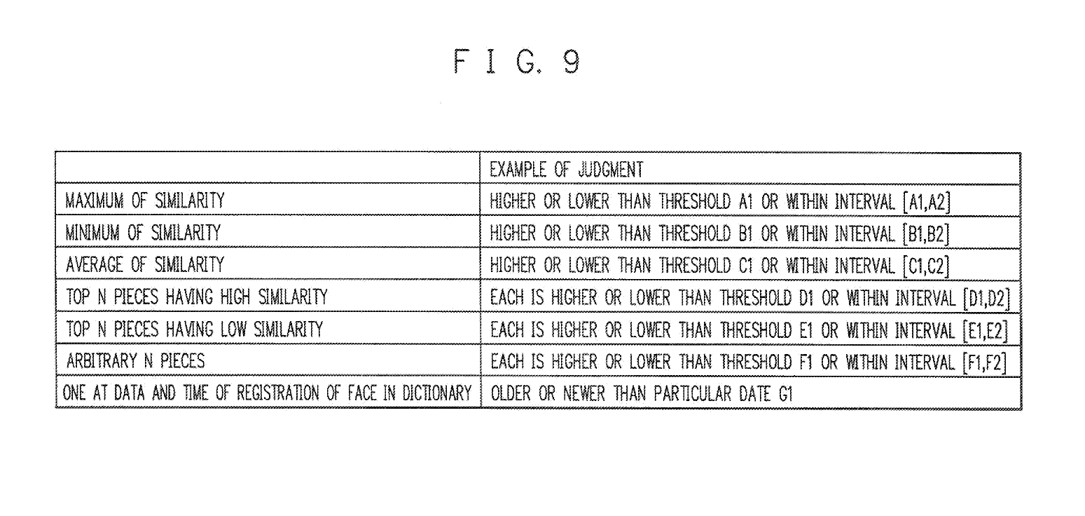

FIG. 9 shows an example of criteria of judgment. A combination of these may be employed or, alternatively, another measure may be added and used. A setup may be employed that all are added to the history. Alternatively, the size of the input image itself or, alternatively, an evaluation result of the image quality may be used.

Returning to FIGS. 6 and 7, on the basis of the judgment result of the history accumulation judgment unit 20100, the inquiry history update unit 20110 updates the inquiry history information (the biological information) accumulated in the inquiry history accumulation unit 20050 (step S20050). The update may be that the face feature quantity (the biological information piece) is simply added newly. As another method, the update may be that, in association with registration of one piece, the oldest one face feature quantity (the biological information piece) is deleted so that the total number in the history is maintained at constant. Further, a form may be employed that, at the time of update, the inquiry history update unit 20110 completely deletes the history face feature quantities (biological information pieces) having been registered before a fixed term, and then maintains only the history face feature quantities (biological information pieces) registered relatively recently.

The history information comparison unit 20060 extracts a pair of combinable face feature quantities (biological information pieces) among the face feature quantities (the biological information pieces) having the same user ID as the user ID of the person judged as identical to the person contained in the inquiry image by the person judgment unit 20040, among the face feature quantities (the biological information pieces) accumulated in the inquiry history accumulation unit 20050 (step S20060). Then, the history information comparison unit 20060 calculates the similarity between the face feature quantities (the biological information pieces) for the detected pair of face feature quantities (biological information pieces) (step S20070) and then judges whether the calculated similarity is greater than a threshold set forth in advance. When the calculated similarity is greater than or equal to the threshold, the history information comparison unit 20060 stores the pair of face feature quantities (biological information pieces) as a pair of similar face feature quantities (step S20080). The threshold may have the same value as the threshold adopted in the biological information comparison unit 20030 or, alternatively, may have a different value. When a value higher than the threshold adopted in the biological information comparison unit 20030 is adopted, those having a high similarity are extracted alone. Thus, although there is a disadvantage that a similar pair is hard to be detected, an advantage is obtained that reliability is increased in the update. The person authentication apparatus performs the processing of steps S20060 to S20080 onto all pairs of face feature quantities (biological information pieces).

The update permission or non-permission judgment unit 20070 receives the result of the pairs of mutually similar face feature quantities (biological information pieces) from the history information comparison unit 20060 and then judges whether update is to be performed (step S20090). In an example, the update permission or non-permission judgment unit 20070 calculates the number of pairs having a similarity higher than the threshold and then, when the number is greater than a value set forth in advance, judges that update is to be performed. The update permission or non-permission judgment may be not judgment based on the total sum alone. That is, normalization by the total number of pairs of face feature quantities (biological information pieces) may be performed.

At step S20090, when it is judged that update is to be performed, the update permission or non-permission user confirmation unit 20120 performs confirmation inquiry to the user or the system administrator (step S20095). The step S20095 of update confirmation need not indispensably be performed and may be performed selectively when necessary. When the processing is to be skipped, the procedure goes directly to step S20100.

At step S20095, when confirmation from the user or the system administrator has been acquired, the registered information update unit 20080 updates the registered information registered in the registered information accumulation unit (the person authentication dictionary) 20020 (step S20100). After that, the processing is terminated.

In an example, the registered information update unit 20080 adopts one from the face feature quantities (biological information pieces) constituting the pairs of face feature quantities (biological information pieces) judged as similar, and then replaces the face feature quantity (the biological information) accumulated in the registered information accumulation unit (the person authentication dictionary) 20020. Further, in a case that the registered information accumulation unit (the person authentication dictionary) 20020 accumulates a plurality of face feature quantities (biological information pieces), the registered information update unit 20080 may perform the processing of adding newly. Further, in place of simply adopting one from the face feature quantities (the biological information pieces), the registered information update unit 20080 may adopt one selected most frequently as a pair among the group of face feature quantities (biological information pieces) constituted by the pairs of similar face feature quantities (biological information pieces). Further, the registered information update unit 20080 may add or replace not one but a plurality of face feature quantities (biological information pieces). When the processing of arithmetic mean or the like is achievable, the arithmetic mean of the face feature quantities (biological information pieces) may be adopted in the update.

When the absence of update has been concluded, the processing is terminated immediately.

When the person authentication apparatus according to the second embodiment is to be constructed from an electronic device, the person authentication apparatus may be realizable by a computer operating under program control. Although not shown in a figure, as known widely, a computer of this kind includes: an input device for receiving input of data; a data processing device; an output device for outputting a processing result from the data processing device; and an auxiliary storage device serving as various databases. Then, the data processing device is constructed from: a read-only memory (ROM) for storing a program; a random-access memory (RAM) serving as a work memory for temporarily storing data; and a central processing unit (CPU) for processing the data stored in the RAM in accordance with the program stored in the ROM.

In this case, the input device serves as the inquiry input unit 20010 and the update permission or non-permission user confirmation unit 20120. The data processing device serves as the feature quantity extraction unit 20090, the biological information comparison unit 20030, the person judgment unit 20040, the history accumulation judgment unit 20100, the inquiry history update unit 20110, the history information comparison unit 20060, the update permission or non-permission judgment unit 20070, and the registered information update unit 20080. Then, the auxiliary storage device serves as the registered information accumulation unit (the person authentication dictionary) 20020 and the inquiry history accumulation unit 20050.

In other words, each section of the person authentication apparatus according to the second embodiment may be realized by employing a combination of hardware and software. In a mode in which hardware and software are combined, the hardware such as a control section (the CPU) is caused to operate in accordance with a person authentication program stored in the ROM so that each section is realized as diverse means. Further, the person authentication program may be distributed in a manner of being recorded on a recording medium. The person authentication program recorded on the recording medium is read onto a memory through a cable, by wireless, or through the recording medium itself and then causes the control section and the like to operate. Here, examples of the recording medium include an optical disk, a magnetic disk, a semiconductor memory device, and a hard disk.

In another form of expression, the second embodiment given above is as follows. An information processing device serving as the person authentication apparatus can be realized when the control section (the CPU) operates as the feature quantity extraction unit 20090, the biological information comparison unit 20030, the person judgment unit 20040, the history accumulation judgment unit 20100, the inquiry history update unit 20110, the history information comparison unit 20060, the update permission or non-permission judgment unit 20070, and the registered information update unit 20080 in accordance with the person authentication program stored in the ROM.

Next, the effect of the person authentication apparatus according to the second embodiment of the present invention is described below.

Update is performed only when, in the inquiry images presented as targets of inquiry within a particular term, the number of pairs of similar face images is greater than or equal to a fixed number. By virtue of this, only when there is a face feature quantity (a biological information piece) stably observed within the particular term, update can be performed by using the face feature quantity (the biological information piece). Thus, an influence from a fluctuation in the inquiry image associated with a transitory input fluctuation, from a short-term change in the target, or from the like can be excluded. Accordingly, the object of the invention can be achieved that the image is updated on the basis of a face feature quantity (a biological information piece) observed in a medium to long term including a temporal change such as aging. Further, an influence from a short-term change in the target or the like can be excluded. Thus, another effect can also be obtained that the quality of the dictionary information can be maintained.

In the second embodiment for implementing the present invention, from the perspective of a person authentication apparatus, the person judgment unit 20040 has been arranged. However, from the perspective of update of the dictionary information accumulated in the registered information accumulation unit (the person authentication dictionary) 20020, it should be noted that the person judgment unit 20040 is not indispensable and hence the other units alone are sufficient for the implementation.

In this case, as described above, the registered information accumulation unit 20020 serves as the person authentication dictionary. Thus, a person authentication apparatus without the person judgment unit 20040 serves as a person authentication dictionary update apparatus.

In a mode in which hardware and software are combined, the hardware such as a control section (the CPU) is caused to operate in accordance with a person authentication dictionary update program stored in the ROM so that each section is realized as diverse means. An information processing device serving as the person authentication dictionary update apparatus can be realized when the control section (the CPU) operates as the feature quantity extraction unit 20090, the biological information comparison unit 20030, the history accumulation judgment unit 20100, the inquiry history update unit 20110, the history information comparison unit 20060, the update permission or non-permission judgment unit 20070, and the registered information update unit 20080 in accordance with the person authentication dictionary update program stored in the ROM.

Further, the person authentication dictionary update program may be distributed in a manner of being recorded on a recording medium. The person authentication program recorded on the recording medium is read onto a memory through a cable, by wireless, or through the recording medium itself and then causes the control section and the like to operate. Here, examples of the recording medium include an optical disk, a magnetic disk, a semiconductor memory device, and a hard disk.

### Third Embodiment

Next, a third embodiment for implementing the present invention is described below with reference to the drawings.

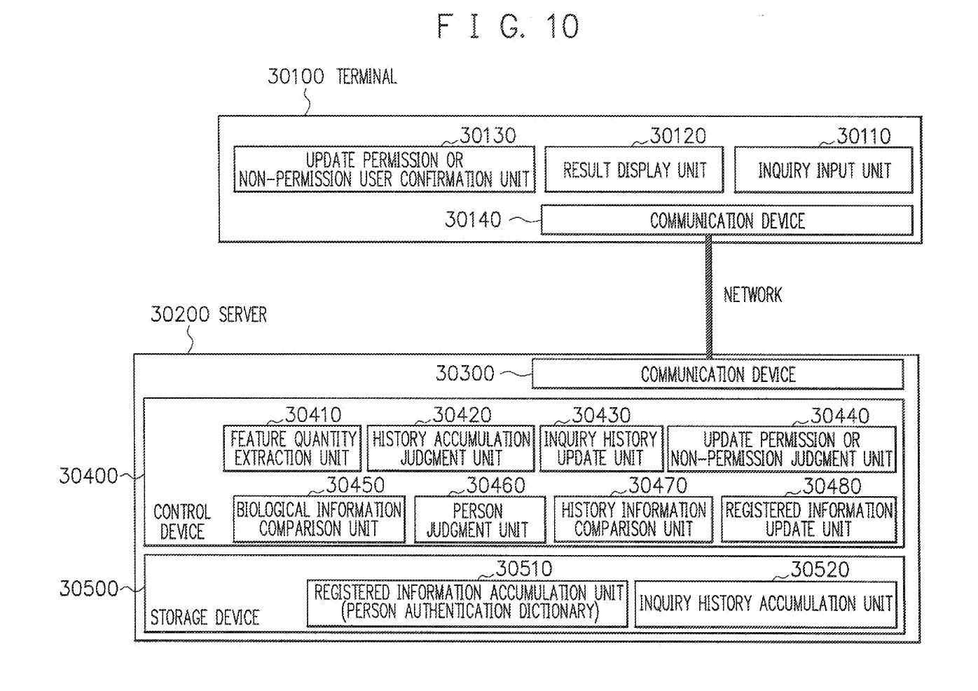

Referring to FIG. 10, the person authentication system according to the third embodiment of the present invention is constructed from: a terminal 30100 including an inquiry input unit 30110, a result display unit 30120, an update permission or non-permission user confirmation unit 30130, and a communication device 30140; and a server 30200 including a communication device 30300, a control device 30400, and a storage device 30500.

The control device 30400 is constructed from a feature quantity extraction unit 30410, a history accumulation judgment unit 30420, an inquiry history update unit 30430, an update permission or non-permission judgment unit 30440, a biological information comparison unit 30450, a person judgment unit 30460, a history information comparison unit 30470, and a registered information update unit 30480.

The storage device 30500 is constructed from a registered information accumulation unit (a person authentication dictionary) 30510 and an inquiry history accumulation unit 30520.

In an example, the terminal 30100 is constructed from a portable terminal such as a portable phone and a smartphone having a photographing function.

In an example, the server 30200 is constructed from a PC, a workstation, or the like capable of being connected to a network.

The inquiry input unit 30110 and the update permission or non-permission user confirmation unit 30130 can respectively be realized by the same configurations of the inquiry input unit 20010 and the update permission or non-permission user confirmation unit 20120 shown in FIG. 6. Thus, their description is omitted.

Further, the feature quantity extraction unit 30410, the history accumulation judgment unit 30420, the inquiry history update unit 30430, the update permission or non-permission judgment unit 30440, the biological information comparison unit 30450, the person judgment unit 30460, the history information comparison unit 30470, and the registered information update unit 30480 can respectively be realized by the same configurations of the feature quantity extraction unit 20090, the history accumulation judgment unit 20100, the inquiry history update unit 20110, the update permission or non-permission judgment unit 20070, the biological information comparison unit 20030, the person judgment unit 20040, the history information comparison unit 20060, and the registered information update unit 20080 shown in FIG. 6. Thus, their description is omitted.

The result display unit 30120 displays the comparison result. In an example, the result display unit 30120 is constructed from a display of a portable terminal. Since to be displayed is a result, in place of a visual display device, a sound output device such as an alarm or, alternatively, a vibration or the like output device may be employed.

The communication devices 30300 and 30140 exchange communication between the terminal 30100 and the server 30200. In an example, the communication devices 30300 and 30140 are dedicated boards for performing communication through a network.

In FIG. 10, a configuration is employed that the processing of feature quantity extraction or the like is allocated to the server 30200. However, a configuration may be employed that a storage device and a control device are provided on the terminal 30100 side and then a part of the functions is allocated to the terminal 30100 side.

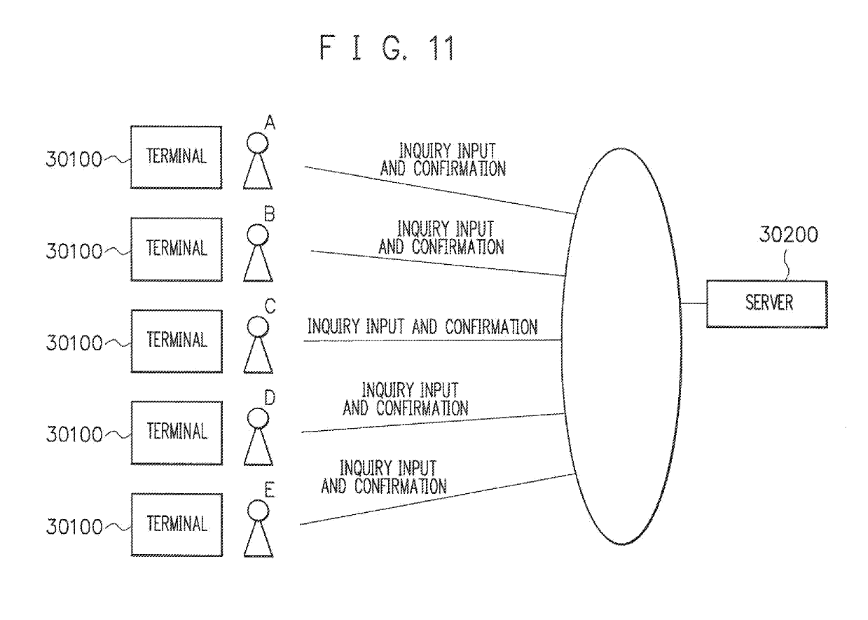

FIG. 11 is a diagram showing an example of utilization of the person authentication system according to the third embodiment. Users individually perform inquiry input through a wireless network. In response to this, the server 30200 performs comparison processing and then sends judgment results to the users. For each user, the server 30200 stores inquiry history information into the inquiry history accumulation unit 30520 and then, in accordance with inquiry from the user, updates the registered information of the user accumulated in the registered information accumulation unit (the person authentication dictionary) 30510.

Here, in each embodiment given above, the processing in the embodiment may be executed in a situation that a program, software, or information coded with computer-executable commands and stored in a computer-readable storage medium are installed in a computer. Such storage media include a recording medium of portable type such as an optical disk, a floppy (registered trademark) disk, and a hard disk, as well as a transmission medium such as a network for temporarily recording and holding data.

The present invention has been described above with reference to embodiments. However, the present invention is not limited to the embodiments given above. Various changes which can be understood by the person skilled in the art within the scope of the present invention may be made on the configurations and the details of the present invention.

A part or all of the embodiments given above may be described as the following additional descriptions. However, the present invention is not limited to these.

(Additional description 1) A person authentication dictionary update method of, by using a person authentication dictionary update apparatus, updating a person authentication dictionary for storing biological information of a person of recognition target, comprising:

a storage step of storing and accumulating inquiry biological information received within a predetermined term, into a history accumulation unit;

a generation step of measuring a similarity of the accumulated inquiry biological information pieces and then generating the similarity of each pair of biological information pieces; and

an update step of, on the basis of a pair of biological information pieces judged as having a high similarity, updating the person authentication dictionary.

(Additional description 2) The person authentication dictionary update method according to additional description 1, wherein

at the update step, when a total number of pairs of similar biological information pieces is greater than or equal to a number set forth in advance, the person authentication dictionary is updated by using at least one biological information piece constituting the pair of biological information pieces judged as having a high similarity.

(Additional description 3) The person authentication dictionary update method according to additional description 1, wherein

at the update step, when a maximum value of biological information pieces adjacent to each other from the perspective of a pair of similar biological information pieces is greater than or equal to a number set forth in advance, the person authentication dictionary is updated by using at least one biological information piece among a group of the biological information pieces giving the maximum value of biological information pieces adjacent to each other.

(Additional description 4) The person authentication dictionary update method according to any one of additional description 1 to 3, wherein:

at the storage step, the inquiry biological information is stored and accumulated into the history accumulation unit for each person of authentication target; and

at the generation step, for each target person, a similarity of the accumulated inquiry biological information pieces is measured and then the similarity of each pair of biological information pieces is generated.

(Additional description 5) The person authentication dictionary update method according to additional description 4, comprising

a comparison step of comparing received inquiry biological information against the person authentication dictionary, wherein

at the storage step, when it is judged that a similarity of the received inquiry biological information calculated at the comparison step is higher than a predetermined similarity, the received inquiry biological information is stored and accumulated into the history accumulation unit as inquiry biological information of the corresponding person.

(Additional description 6) The person authentication dictionary update method according to additional description 4, comprising

a comparison step of comparing received inquiry biological information against the person authentication dictionary, wherein

at the storage step, when the similarity of the received inquiry biological information calculated at the comparison step is higher than a first similarity set forth in advance and lower than a second similarity set forth in advance, the received inquiry biological information is stored and accumulated into the history accumulation unit as inquiry biological information of the corresponding person.

(Additional description 7) The person authentication dictionary update method according to any one of additional descriptions 4 to 6, wherein

at the storage step, when a target person is identified by a method other than comparison of inquiry biological information against the person authentication dictionary, the inquiry biological information is stored and accumulated into the history accumulation unit as inquiry biological information of the corresponding person.

(Additional description 8) The person authentication dictionary update method according to any one of additional descriptions 1 to 7, wherein

at the storage step, as the inquiry biological information, a feature quantity extracted from biological information is stored and accumulated into the history accumulation unit.

(Additional description 9) The person authentication dictionary update method according to any one of additional descriptions 1 to 8, further comprising

a confirmation step of, when inquiry biological information used for the update is selected, confirming presence or absence of update, to a user or an administrator, wherein

at the update step, update is performed when an update instruction has been issued at the confirmation step.

(Additional description 10) The person authentication dictionary update method according to any one of additional descriptions 1 to 9, wherein

the biological information of a person is at least any one of a face image, a fingerprint image, iris information, a shape-of-palm image, a finger image, and speech information.

(Additional description 11) A person authentication dictionary update apparatus for updating a person authentication dictionary for storing biological information of a person of recognition target, comprising:

a storage unit for storing and accumulating inquiry biological information received within a predetermined term, into a history accumulation unit;

a generation unit for measuring a similarity of the accumulated inquiry biological information pieces and then generating the similarity of each pair of biological information pieces; and

an update section for, on the basis of a pair of biological information pieces judged as having a high similarity, updating the person authentication dictionary.

(Additional description 12) The person authentication dictionary update apparatus according to additional description 11, wherein

the update section, when a total number of pairs of similar biological information pieces is greater than or equal to a number set forth in advance, updates the person authentication dictionary by using at least one biological information piece constituting the pair of biological information pieces judged as having a high similarity.

(Additional description 13) The person authentication dictionary update apparatus according to additional description 11, wherein

the update section, when a maximum value of biological information pieces adjacent to each other from the perspective of a pair of similar biological information pieces is greater than or equal to a number set forth in advance, updates the person authentication dictionary by using at least one biological information piece among a group of the biological information pieces giving the maximum value of biological information pieces adjacent to each other.

(Additional description 14) The person authentication dictionary update apparatus according to any one of additional descriptions 11 to 13, wherein:
the storage unit stores and accumulates the inquiry biological information into the history accumulation unit for each person of authentication target; and

for each target person, the generation unit measures a similarity of the accumulated inquiry biological information pieces and then generates the similarity of each pair of biological information pieces.

(Additional description 15) The person authentication dictionary update apparatus according to additional description 14, comprising

a comparison unit for comparing received inquiry biological information against the person authentication dictionary, wherein

the storage unit, when it is judged that a similarity of the received inquiry biological information calculated in the comparison unit is higher than a predetermined similarity, stores and accumulates the received inquiry biological information into the history accumulation unit as inquiry biological information of the corresponding person.

(Additional description 16) The person authentication dictionary update apparatus according to additional description 14, comprising

a comparison unit for comparing received inquiry biological information against the person authentication dictionary, wherein

the storage unit, when the similarity of the received inquiry biological information calculated in the comparison unit is higher than a first similarity set forth in advance and lower than a second similarity set forth in advance, stores and accumulates the received inquiry biological information into the history accumulation unit as inquiry biological information of the corresponding person.

(Additional description 17) The person authentication dictionary update apparatus according to any one of additional descriptions 14 to 16, wherein

the storage unit, when a target person is identified by a method other than comparison of inquiry biological information against the person authentication dictionary, stores and accumulates the inquiry biological information into the history accumulation unit as inquiry biological information of the corresponding person.

(Additional description 18) The person authentication dictionary update apparatus according to any one of additional descriptions 11 to 17, wherein

the storage unit stores and accumulates as the inquiry biological information a feature quantity extracted from biological information into the history accumulation unit.

(Additional description 19) The person authentication dictionary update apparatus according to any one of additional descriptions 11 to 18, further comprising

a confirmation unit for, when inquiry biological information used for the update is selected, confirming presence or absence of update, to a user or an administrator, wherein

the update section performs update when an update instruction has been issued by the confirmation unit.

(Additional description 20) The person authentication dictionary update apparatus according to any one of additional descriptions 11 to 19, wherein

the biological information of a person is at least any one of a face image, a fingerprint image, iris information, a shape-of-palm image, a finger image, and speech information.

(Additional description 21) A computer-readable recording medium storing a person authentication dictionary update program for causing a computer to update a person authentication dictionary for storing biological information of a person of recognition target, causing the computer to execute:

a storage procedure of storing and accumulating inquiry biological information received within a predetermined term, into a history accumulation unit;

a generation procedure of measuring a similarity of the accumulated inquiry biological information pieces and then generating the similarity of each pair of biological information pieces; and

an update procedure of, on the basis of a pair of biological information pieces judged as having a high similarity, updating the person authentication dictionary.

(Additional description 22) The computer-readable recording medium storing a person authentication dictionary update program according to additional description 21, wherein

in the update procedure, when a total number of pairs of similar biological information pieces is greater than or equal to a number set forth in advance, the computer is caused to update the person authentication dictionary by using at least one biological information piece constituting the pair of biological information pieces judged as having a high similarity.

(Additional description 23) The computer-readable recording medium storing a person authentication dictionary update program according to additional description 21, wherein

in the update procedure, when a maximum value of biological information pieces adjacent to each other from the perspective of a pair of similar biological information pieces is greater than or equal to a number set forth in advance, the computer is caused to update the person authentication dictionary by using at least one biological information piece among a group of the biological information pieces giving the maximum value of biological information pieces adjacent to each other.

(Additional description 24) The computer-readable recording medium storing a person authentication dictionary update program according to any one of additional descriptions 21 to 23, wherein:

in the storing procedure, the computer is caused to store and accumulate the inquiry biological information into the history accumulation unit for each person of authentication target; and

in the generation procedure, for each target person, the computer is caused to measure a similarity of the accumulated inquiry biological information pieces and then generate the similarity of each pair of the biological information pieces.

(Additional description 25) The computer-readable recording medium storing a person authentication dictionary update program according to additional description 24, wherein:

the computer is caused to further execute a comparison procedure of comparing received inquiry biological information against the person authentication dictionary; and

in the storage procedure, when it is judged that a similarity of the received inquiry biological information calculated in the comparison procedure is higher than a predetermined similarity, the computer is caused to store and accumulate the received inquiry biological information into the history accumulation unit as inquiry biological information of the corresponding person.

(Additional description 26) The computer-readable recording medium storing a person authentication dictionary update program according to additional description 24, wherein:

the computer is caused to further execute a comparison procedure of comparing received inquiry biological information against the person authentication dictionary; and

in the storage procedure, when the similarity of the received inquiry biological information calculated in the comparison procedure is higher than a first similarity set forth in advance and lower than a second similarity set forth in advance, the computer is caused to store and accumulate the received inquiry biological information into the inquiry history accumulation unit as biological information of the corresponding person.

(Additional description 27) The computer-readable recording medium storing a person authentication dictionary update program according to any one of additional descriptions 24 to 26, wherein

in the storage procedure, when a target person is identified by a method other than comparison of inquiry biological information against the person authentication dictionary, the computer is caused to store and accumulate the inquiry biological information into the history accumulation unit as inquiry biological information of the corresponding person.

(Additional description 28) The computer-readable recording medium storing a person authentication dictionary update program according to any one of additional descriptions 21 to 27, wherein

in the storing procedure, the computer is caused to store and accumulate as the inquiry biological information a feature quantity extracted from biological information into the history accumulation unit.

(Additional description 29) The computer-readable recording medium storing a person authentication dictionary update program according to any one of additional descriptions 21 to 28, wherein:

when inquiry biological information used for the update is selected, the computer is caused to further execute a confirmation procedure of confirming presence or absence of update, to a user or an administrator; and

in the update procedure, the computer is caused to perform update when an update instruction has been issued in the confirmation procedure.

(Additional description 30) The computer-readable recording medium storing a person authentication dictionary update program according to any one of additional descriptions 21 to 29, wherein

the biological information of a person is at least any one of a face image, a fingerprint image, iris information, a shape-of-palm image, a finger image, and speech information.

(Additional description 31) A person authentication system constructed from at least one terminal and a server and performing authentication of a person, the server comprising:

a person authentication dictionary for storing biological information of the person of recognition target;

a storage unit for storing and accumulating inquiry biological information received from the at least one terminal within a predetermined term, into a history accumulation unit;

a generation unit for measuring a similarity of the accumulated inquiry biological information pieces and then generating the similarity of each pair of biological information pieces;

an update section for, on the basis of a pair of biological information pieces judged as having a high similarity, updating the person authentication dictionary; and

a comparison unit for comparing inquiry biological information received from the at least one terminal, against the person authentication dictionary.

(Additional description 32) The person authentication system according to additional description 31, wherein

in the update section, when a total number of pairs of similar biological information pieces is greater than or equal to a number set forth in advance, the person authentication dictionary is updated by using at least one biological information piece constituting the pair of biological information pieces judged as having a high similarity.

(Additional description 33) The person authentication system according to additional description 31, wherein

in the update section, when a maximum value of biological information pieces adjacent to each other from the perspective of a pair of similar biological information pieces is greater than or equal to a number set forth in advance, the person authentication dictionary is updated by using at least one biological information piece among a group of the biological information pieces giving the maximum value of biological information pieces adjacent to each other.

(Additional description 34) The person authentication system according to any one of additional descriptions 31 to 33, wherein:

the storage unit stores and accumulates the inquiry biological information into the history accumulation unit for each person of authentication target; and

for each target person, the generation unit measures a similarity of the accumulated inquiry biological information pieces and then generates the similarity of each pair of biological information pieces.

(Additional description 35) The person authentication system according to additional description 34, wherein

when it is judged that a similarity of the received inquiry biological information calculated in the comparison unit is higher than a predetermined similarity, the storage unit stores and accumulates the received inquiry biological information into the history accumulation unit as inquiry biological information of the corresponding person.

(Additional description 36) The person authentication system according to additional description 34, wherein

when the similarity of the received inquiry biological information calculated in the comparison unit is higher than a first similarity set forth in advance and lower than a second similarity set forth in advance, the storage unit stores and accumulates the received inquiry biological information into the history accumulation unit as inquiry biological information of the corresponding person.

(Additional description 37) The person authentication system according to any one of additional descriptions 34 to 36, wherein

when a target person is identified by a method other than comparison of inquiry biological information against the person authentication dictionary, the storage unit stores and accumulates the inquiry biological information into the history accumulation unit as inquiry biological information of the corresponding person.

(Additional description 38) The person authentication system according to any one of additional descriptions 31 to 37, wherein

the storage unit stores and accumulates as the inquiry biological information a feature quantity extracted from biological information into the history accumulation unit.

(Additional description 39) The person authentication system according to any one of additional descriptions 31 to 38, wherein:

the at least one terminal includes a confirmation unit for, when inquiry biological information used for the update is selected, confirming presence or absence of update, to a user or an administrator; and

the update section performs update when an update instruction has been issued by the confirmation unit.

(Additional description 40) The person authentication system according to any one of additional descriptions 31 to 39, wherein

the biological information of a person is at least any one of a face image, a fingerprint image, iris information, a shape-of-palm image, a finger image, and speech information.

### INDUSTRIAL APPLICABILITY

The present invention is applicable to a system for performing administration of entering and exiting in a building, work administration, or the like by using biological information. Further, the present invention is applicable to a system for performing user confirmation at the time of utilization of a terminal such as a portable phone of an individual person, by using biological information. Furthermore, the present invention is applicable to a situation that, in a social network service or the like employing portable terminals or the like, in a communication system for exchanging information between members registered in advance, biological information is used in specification or administration of persons of exchange targets. Further, in addition to such social network services, the present invention is applicable to a wide variety of biometric authentication systems for utilization administration, communication member administration, information research, and the like by using biometric authentication, like applications to authentication systems and the like for intercompany communication, business utilization, communication in an exhibition or the like.

### DESCRIPTION OF REFERENCE NUMERALS

10010 Inquiry input unit
10020 Registered information accumulation unit (person authentication dictionary)
10030 Biological information comparison unit
10040 Person judgment unit
10050 Inquiry history accumulation unit
10060 History information comparison unit
10070 Update permission or non-permission judgment unit
10080 Registered information update unit
20010 Inquiry input unit
20020 Registered information accumulation unit (person authentication dictionary)
20030 Biological information comparison unit
20040 Person judgment unit
20050 Inquiry history accumulation unit
20060 History information comparison unit
20070 Update permission or non-permission judgment unit
20080 Registered information update unit
20090 Feature quantity extraction unit
20100 History accumulation judgment unit
20110 Inquiry history update unit
20120 Update permission or non-permission user confirmation unit
30100 Terminal
30110 Inquiry input unit
30120 Result display unit
30130 Update permission or non-permission user confirmation unit
30140 Communication device
30200 Server
30300 Communication device
30400 Control device
30410 Feature quantity extraction unit
30420 History accumulation judgment unit
30430 Inquiry history update unit
30440 Update permission or non-permission judgment unit
30450 Biological information comparison unit
30460 Person judgment unit
30470 History information comparison unit
30480 Registered information update unit
30500 Storage device
30510 Registered information accumulation unit (person authentication dictionary)
30520 Inquiry history accumulation unit

This application is based upon and claims the benefit of priority from Japanese patent application No. 2012-211273, filed on Sep. 25, 2012, the disclosure of which is incorporated herein its entirety by reference.

1. A person authentication dictionary update method of, by using a person authentication dictionary update apparatus, updating a person authentication dictionary for storing biological information of a person of recognition target, comprising:
a storage step of storing and accumulating inquiry biological information received within a predetermined term, into a history accumulation unit;
a generation step of measuring a similarity of the accumulated inquiry biological information pieces and then generating the similarity of each pair of biological information pieces; and
an update step of, on the basis of a pair of biological information pieces judged as having a high similarity, updating the person authentication dictionary.

2. The person authentication dictionary update method according to claim 1, wherein
at the update step, when a total number of pairs of similar biological information pieces is greater than or equal to a number set forth in advance, the person authentication dictionary is updated by using at least one biological information piece constituting the pair of biological information pieces judged as having a high similarity.

3. The person authentication dictionary update method according to claim 1, wherein
at the update step, when a maximum value of biological information pieces adjacent to each other from the perspective of a pair of similar biological information pieces is greater than or equal to a number set forth in advance, the person authentication dictionary is updated by using at least one biological information piece among a group of the biological information pieces giving the maximum value of biological information pieces adjacent to each other.

4. The person authentication dictionary update method according to of claim 1, wherein
at the storage step, the inquiry biological information is stored and accumulated into the history accumulation unit for each person of authentication target; and
at the generation step, for each target person, a similarity of the accumulated inquiry biological information pieces is measured and then the similarity of each pair of biological information pieces is generated.

5. The person authentication dictionary update method according to claim 4, comprising:
a comparison step of comparing received inquiry biological information against the person authentication dictionary, wherein
at the storage step, when it is judged that a similarity of the received inquiry biological information calculated at the comparison step is higher than a predetermined similarity, the received inquiry biological information is stored and accumulated into the history accumulation unit as inquiry biological information of the corresponding person.

6. The person authentication dictionary update method according to claim 4, comprising:
a comparison step of comparing received inquiry biological information against the person authentication dictionary, wherein
at the storage step, when the similarity of the received inquiry biological information calculated at the comparison step is higher than a first similarity set forth in advance and lower than a second similarity set forth in advance, the received inquiry biological information is stored and accumulated into the history accumulation unit as inquiry biological information of the corresponding person.

7. The person authentication dictionary update method according to claim 1, further comprising:
a confirmation step of, when inquiry biological information used for the update is selected, confirming presence or absence of update, to a user or an administrator, wherein
at the update step, update is performed when an update instruction has been issued at the confirmation step.

8. A person authentication dictionary update apparatus for updating a person authentication dictionary for storing biological information of a person of recognition target, comprising:
a storage unit for storing and accumulating inquiry biological information received within a predetermined term, into a history accumulation unit;
a generation unit for measuring a similarity of the accumulated inquiry biological information pieces and then generating the similarity of each pair of biological information pieces; and
an update section for, on the basis of a pair of biological information pieces judged as having a high similarity, updating the person authentication dictionary.

9. A computer-readable recording medium storing a person authentication dictionary update program for causing a computer to update a person authentication dictionary for storing biological information of a person of recognition target, causing the computer to execute:
a storage procedure of storing and accumulating inquiry biological information received within a predetermined term, into a history accumulation unit;
a generation procedure of measuring a similarity of the accumulated inquiry biological information pieces and then generating the similarity of each pair of biological information pieces; and
an update procedure of, on the basis of a pair of biological information pieces judged as having a high similarity, updating the person authentication dictionary.

10. A person authentication system constructed from at least one terminal and a server and performing authentication of a person, the server comprising:
a person authentication dictionary for storing biological information of the person of recognition target;
a storage unit for storing and accumulating inquiry biological information received from the at least one terminal within a predetermined term, into a history accumulation unit;
a generation unit for measuring a similarity of the accumulated inquiry biological information pieces and then generating the similarity of each pair of biological information pieces;
an update section for, on the basis of a pair of biological information pieces judged as having a high similarity, updating the person authentication dictionary; and
a comparison unit for comparing inquiry biological information received from the at least one terminal, against the person authentication dictionary.

11. The person authentication dictionary update method according to claim 2, wherein
at the storage step, the inquiry biological information is stored and accumulated into the history accumulation unit for each person of authentication target; and
at the generation step, for each target person, a similarity of the accumulated inquiry biological information pieces is measured and then the similarity of each pair of biological information pieces is generated.

12. The person authentication dictionary update method according to claim 3, wherein
at the storage step, the inquiry biological information is stored and accumulated into the history accumulation unit for each person of authentication target; and
at the generation step, for each target person, a similarity of the accumulated inquiry biological information pieces is measured and then the similarity of each pair of biological information pieces is generated.

13. The person authentication dictionary update method according to claim 11, comprising:
a comparison step of comparing received inquiry biological information against the person authentication dictionary, wherein
at the storage step, when it is judged that a similarity of the received inquiry biological information calculated at the comparison step is higher than a predetermined similarity, the received inquiry biological information is stored and accumulated into the history accumulation unit as inquiry biological information of the corresponding person.

14. The person authentication dictionary update method according to claim 12, comprising:
a comparison step of comparing received inquiry biological information against the person authentication dictionary, wherein
at the storage step, when it is judged that a similarity of the received inquiry biological information calculated at the comparison step is higher than a predetermined similarity, the received inquiry biological information is stored and accumulated into the history accumulation unit as inquiry biological information of the corresponding person.

15. The person authentication dictionary update method according to claim 2, further comprising:
a confirmation step of, when inquiry biological information used for the update is selected, confirming presence or absence of update, to a user or an administrator, wherein
at the update step, update is performed when an update instruction has been issued at the confirmation step.

16. The person authentication dictionary update method according to claim 3, further comprising:
a confirmation step of, when inquiry biological information used for the update is selected, confirming presence or absence of update, to a user or an administrator, wherein
at the update step, update is performed when an update instruction has been issued at the confirmation step.

17. The person authentication dictionary update method according to claim 4, further comprising:
a confirmation step of, when inquiry biological information used for the update is selected, confirming presence or absence of update, to a user or an administrator, wherein
at the update step, update is performed when an update instruction has been issued at the confirmation step.

18. The person authentication dictionary update method according to claim 5, further comprising:
a confirmation step of, when inquiry biological information used for the update is selected, confirming presence or absence of update, to a user or an administrator, wherein
at the update step, update is performed when an update instruction has been issued at the confirmation step.

19. The person authentication dictionary update method according to claim 11, further comprising:
a confirmation step of, when inquiry biological information used for the update is selected, confirming presence or absence of update, to a user or an administrator, wherein
at the update step, update is performed when an update instruction has been issued at the confirmation step.

20. The person authentication dictionary update method according to claim 12, further comprising:
a confirmation step of, when inquiry biological information used for the update is selected, confirming presence or absence of update, to a user or an administrator, wherein
at the update step, update is performed when an update instruction has been issued at the confirmation step.
